(19) United States
(12) Patent Application Publication
(10) Pub. No.: US 2026/0103625 A1
(43) Pub. Date: Apr. 16, 2026

(54) ADHESIVE COMPOUND, ADHESIVE TAPE, BONDED COMPOSITE, AND METHOD FOR ELECTRICALLY DEBONDING THE BONDED COMPOSITE

(71) Applicant: tesa SE, Norderstedt (DE)

(72) Inventors: Franciska Rademacher, Itzehoe (DE); Ann-Kathrin Nägele, Hamburg (DE); Anika Petersen, Heidmuhlen (DE); Hans-Peter Graef, Hamburg (DE)

(73) Assignee: tesa SE, Norderstedt (DE)

(21) Appl. No.: 19/234,861

(22) Filed: Jun. 11, 2025

(30) Foreign Application Priority Data
Jun. 11, 2024 (DE) 102024116261.9
Jul. 25, 2024 (DE) 102024121139.3

(51) Int. Cl. C09J 7/38; C09J 11/04; C09J 11/06; C09J 11/08; C09J 131/02; C09J 153/00

(52) U.S. Cl. CPC C09J 7/387; C09J 11/04; C09J 11/06; C09J 11/08; C09J 131/02; C09J 153/00; C09J 2301/302; C09J 2301/314; C09J 2301/408; C09J 2301/414

(57) ABSTRACT

The disclosure relates to an adhesive compound, to an adhesive tape, to a bonded composite, to a method for electrically debonding the bonded composite, and to the use of the adhesive compound for the bonding of components in electronic devices, automobiles, medical devices, and dental devices. The adhesive compound includes at least one electrolyte and a base compound, wherein the base compound comprises at least one first phase (i) including at least one poly(meth)acrylate and at least one second phase (ii) including at least one vinylaromatic block copolymer, such as in particular styrene block copolymer, wherein the adhesive compound contains at least 2.5 parts by weight of electrolytes based on 100 parts by weight of the base compound.

### CROSS-REFERENCE TO RELATED APPLICATION

This Application claims of right for priority to German Patent Application No. 102024116261.9 filed 11 Jun. 2024 and German Patent Application No. 102024121139.3 filed 25 Jul. 2024, the contents of which are both incorporated herein in their entireties.

### TECHNICAL FIELD

The disclosure relates to an adhesive compound, to an adhesive tape, to a bonded composite, to a method for electrically debonding the bonded composite, and to the use of the adhesive compound for the bonding of components in electronic devices, automobiles, medical devices, and dental devices.

### BACKGROUND

In recent times there has been growing interest in “debonding-on-demand” functionalities, this being driven by environmental legislation and customer awareness of sustainability and by increasing cost pressures in production. The use scenarios for debonding processes are classified into rework, repair, recycling, and processing aids.

Debonding technologies aim to achieve a cohesive split in the adhesive layer or an adhesive detachment of the adhesive layer from the substrate. Whereas the former necessitates cleaning the substrate before rebonding, in the latter case this is not required.

However, adhesive debonding technologies that guarantee the required high and enduringly reliable bond strength are generally relatively difficult to realize or their application, for example detachment using an infiltrating solvent, is very time-consuming.

For instance, particularly in the rework or repair of electronic devices, such as smartphones and tablet computers, it is predominantly cohesively splitting adhesive bonds that are currently employed, often in the form of pressure-sensitive adhesive tapes, the cohesion of which is reduced by an increase in temperature to such an extent that manual, cohesive separation of the bond can take place. This results in extensive rework to prepare the substrate surface contaminated with adhesive residues for rebonding.

In addition to heat-mediated separation methods, electrical separation methods are being discussed. For example, EP 3031875 B1 discloses lowering the strength of adhesion of an acrylate adhesive compound by applying a voltage.

In addition to electrical detachability through the application of a voltage, an initial strength of adhesion and high shear strengths are however desirable for the applicability of debondable adhesive compounds in electronic devices.

### SUMMARY

An object of the present disclosure is therefore to provide an adhesive compound that can be electrically detached and at the same time has a high initial strength of adhesion as well as good or improved shear strengths, more particularly static and dynamic shear strengths. At the same time, redetachment should be achievable as easily and cleanly as possible. A supplementary object is to provide a corresponding advantageous adhesive tape.

It is an additional object to specify a bonded composite and a method for redetaching the adhesive bond produced by the adhesive compound or adhesive tape.

In addition, it is an object of the disclosure to provide for a use of the provided adhesive compounds or adhesive tapes for the bonding of two or more substrates.

### BRIEF DESCRIPTION OF THE DRAWINGS

In the following, preferred embodiments of the disclosure are elucidated and described more particularly with reference to the accompanying figures. In these figures:

FIG. 1 shows a simplified schematic cross-sectional representation through a double-sided adhesive tape of the disclosure in a preferred embodiment;

FIG. 2 shows a simplified schematic cross-sectional representation through a double-sided adhesive tape of the disclosure in a preferred embodiment;

FIG. 3 shows a simplified schematic cross-sectional representation through a double-sided adhesive tape of the disclosure in a preferred embodiment;

FIG. 4 shows a simplified schematic cross-sectional representation through a bonded composite of the disclosure in a preferred embodiment;

FIG. 5 shows a simplified schematic cross-sectional representation through a bonded composite of the disclosure to which a voltage is being applied, in a preferred embodiment;

FIG. 6 shows a simplified schematic cross-sectional representation through a bonded composite of the disclosure after a voltage has been applied and an adhesive split has occurred as a result;

FIG. 7 shows a simplified schematic cross-sectional representation through a bonded composite of the disclosure in a preferred embodiment; and

FIG. 8 shows a simplified schematic cross-sectional representation through a bonded composite of the disclosure in a preferred embodiment.

### DETAILED DESCRIPTION

Embodiments that are hereinafter designated as preferred are in particular preferred embodiments combined with features of other embodiments designated as preferred. Very particular preference is therefore given to combinations of two or more of the embodiments designated below as particularly preferred. Preference is likewise given to embodiments in which a feature of one embodiment designated as preferred in any level of preference is combined with one or more further features of other embodiments designated as preferred in any level of preference. The disclosure thus encompasses combinations of individual features with one another and also with different levels of preference in said combinations. For instance, the disclosure encompasses for example the combination of a first feature designated as “preferred” with a second feature designated as “particularly preferred”. This likewise encompasses different levels of preference for subject matters referred to in the context of “embodiments”. Features of preferred adhesive tapes, bonded composites, and also uses and methods arise from the features of preferred adhesive compounds. Features of preferred bonded composites, uses, and methods also arise from the features of preferred adhesive tapes.

The adhesive compound of the disclosure comprises at least one electrolyte and a base compound, wherein the base compound comprises at least one first phase (i) comprising at least one poly(meth)acrylate, and at least one second phase (ii) comprising at least one vinylaromatic block copolymer, such as in particular styrene block copolymer, wherein the adhesive compound contains at least 2.5 parts by weight of electrolytes based on 100 parts by weight of the base compound.

By virtue of the electrolyte present, it is possible, by applying a voltage, to electrically detach the adhesive compound even after bonding.

Surprisingly, it has been found that an adhesive compound comprising a blend of at least one first phase (i) comprising at least one poly(meth)acrylate and at least one second phase (ii) comprising at least one vinylaromatic block copolymer and at least one electrolyte can in a simple and quick manner without major force be electrically redetached from bonded substrates by applying a voltage, and at the same time the dynamic and static shear strength of the adhesive compound is improved. Moreover, the adhesive compound has a high strength of adhesion prior to applying the voltage.

Adhesive compounds and methods for electrical redetachment and for electrical reduction of the strength of adhesion are known in principle in the prior art. For instance, as set out above, EP 3031875 B1 discloses such an electrical method. The electrically detachable adhesive compound is in this case an acrylate-based adhesive compound.

However, it was not foreseeable in the present case that an adhesive compound comprising a blend of acrylate and vinylaromatic block copolymer also could be electrically detached after bonding without adverse effect on the strength of adhesion to the substrates to be bonded prior to debonding. In particular, vinylaromatic block copolymer-containing adhesive compounds, which have a nonpolar character on account of the high proportion of hydrocarbon compounds, could not have been assumed to be combinable at all with electrolytes in a form that not only achieves attractive adhesive properties, in particular pressure-sensitive adhesive properties, but also permits detachment by applying a voltage.

Detachment is at the same time clean and easy.

Furthermore, it was not foreseeable that the adhesive compounds of the disclosure would have improved shear strengths, both static and dynamic.

The adhesive compound of the disclosure is elucidated more particularly hereinbelow.

The adhesive compound comprises a base compound and at least one electrolyte, the amount of which is related to the amount of the base compound.

An “electrolyte”, according to the general understanding of those skilled in the art, is understood in the present case as meaning a chemical compound that is dissociated into ions in the solid, liquid or dissolved state and that moves in a directed manner under the influence of an electric field.

The electrolyte is preferably selected from the group consisting of ionic liquids and metal salts, ionic liquids being particularly preferred.

In particular, it is possible by means of one or more ionic liquids as electrolyte to easily redetach the adhesive tape without this adversely affecting the adhesive properties of the adhesive tape. Ionic liquids have the advantage here of being easily and homogeneously dispersible in the polymer matrix of adhesive compounds and that redetachment occurs more rapidly than with other electrolytes.

Furthermore, the constituents of ionic liquids are nonvolatile, in particular at room temperature. Ionic liquids are moreover relatively heat-resistant and non-flammable, as well as chemically relatively stable.

Ionic liquids are in the context of the present disclosure salts that are liquid at room temperature, i.e. 23° C. Ionic liquids accordingly comprise anions and cations.

Ionic liquids are therefore particularly well suited as electrolytes in the context of the separation method/method for electrical debonding of the disclosure.

When a voltage is applied, the anions migrate to the anode side and the cations migrate to the cathode side. Without wishing to be limited thereto, it can be mechanistically assumed that this causes a lowering of the strength of adhesion of the adhesive compound comprising the ionic liquid to at least one substrate, thereby achieving an adhesive split between the adhesive compound and the at least one substrate.

All ionic liquids are in principle suitable in the context of the present disclosure.

The ionic liquids used in the context of the present disclosure comprise at least one anion and at least one cation. It is also conceivable here that the ionic liquid comprises two or more types of anion and/or two or more types of cation. It is also conceivable that two or more different ionic liquids are added to the adhesive compound or that the adhesive compound then comprises two or more different ionic liquids.

Preferably, the anion of the ionic liquid is selected from the group consisting of: Br⁻, AlCl₄⁻, Al₂Cl⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻ (CF₃CF₂SO₂)₂N⁻, CF₃CF₂CF₂COO⁻, N(CN)₂⁻, and (FSO₂)₂N⁻.

Particularly preferably, the anion is selected from (CF₃SO₂)₂N⁻, N(CN)₂⁻, (FSO₂)₂N⁻, PF₆⁻, and tetrafluoroborate (BF₄⁻).

By applying a voltage, this achieves a particularly high reduction in strength of adhesion and thus particularly good electrical detachability of the adhesive compound of the disclosure or adhesive tape of the disclosure. In particular, this anion achieves particularly swift (re)detachment and no residues are left behind.

Alternatively, the anion of the ionic liquid is preferably selected from the group consisting of: Br⁻, AlCl₄⁻, Al₂Cl⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻ (CF₃CF₂SO₂)₂N⁻, CF₃CF₂CF₂COO⁻, and (FSO₂)₂N⁻.

Alternatively, the anion is particularly preferably selected from (CF₃SO₂)₂N⁻, (FSO₂)₂N⁻, PF₆⁻, and tetrafluoroborate (BF₄⁻).

By applying a voltage, this achieves a particularly high reduction in strength of adhesion and thus particularly good electrical detachability of the adhesive compound of the disclosure or adhesive tape of the disclosure. In particular, this anion achieves particularly swift (re)detachment and no residues are left behind.

Preferably, the cation of the ionic liquid is selected from the group consisting of imidazolium-based cations, pyridinium-based cations, pyrrolidine-based cations, and ammonium-based cations.

Particularly preferably, the cation is selected from the group consisting of imidazolium-based cations.

By applying a voltage, this achieves a particularly high reduction in strength of adhesion and thus particularly good electrical detachability of the adhesive compound of the disclosure or adhesive tape of the disclosure. In particular, this anion achieves particularly swift (re)detachment and no residues are left behind.

Very particularly preferably, the cation is selected from the group consisting of 1-ethyl-3-methylimidazolium and 1-butyl-3-methylimidazolium.

Even more preferably, the cation is 1-ethyl-3-methylimidazolium.

Particularly preferably, the electrolyte is selected from the group consisting of the ionic liquids 1-ethyl-3-methylimidazolium dicyanamide, 1-ethyl-3-methylimidazolium bis(trifluoromethylsulfonyl)imide (EMIM-TFSI), 1-ethyl-3-methylimidazolium bis(fluorosulfonyl)imide (EMIM-FSI), 1-butyl-3-methylimidazolium hexafluorophosphate, and 1-ethyl-3-methylimidazolium tetrafluoroborate.

By applying a voltage, this achieves a particularly high reduction in strength of adhesion and thus particularly good electrical detachability of the adhesive compound of the disclosure or adhesive tape of the disclosure. In particular, this anion achieves particularly swift (re)detachment and no residues are left behind.

Alternatively, the electrolyte is particularly preferably selected from the group consisting of the ionic liquids 1-ethyl-3-methylimidazolium bis(trifluoromethylsulfonyl)imide (EMIM-TFSI), 1-ethyl-3-methylimidazolium bis(fluorosulfonyl)imide (EMIM-FSI), 1-butyl-3-methylimidazolium hexafluorophosphate, and 1-ethyl-3-methylimidazolium tetrafluoroborate.

Very particular preference is given to 1-ethyl-3-methylimidazolium bis(trifluoromethylsulfonyl)imide (EMIM-TFSI) and/or 1-ethyl-3-methylimidazolium bis(fluorosulfonyl)imide (EMIM-FSI).

Even greater preference is given here to 1-ethyl-3-methylimidazolium bis(fluorosulfonyl)imide (EMIM-FSI).

The adhesive compound of the disclosure contains at least 2.5 parts by weight of electrolytes based on 100 parts by weight of the base compound.

It is preferable that the adhesive compound contains 2.5 to 10 parts by weight, preferably 2.5 to 8 parts by weight, of electrolytes, preferably ionic liquids, based on 100 parts by weight of the base compound.

With such a preferred or particularly preferred amount of electrolytes, and of ionic liquids in particular, a relatively rapid electrical detachment is made possible without this at the same time having any adverse effect prior to detachment on the adhesion of the adhesive compound to in particular at least one substrate.

The adhesive compound of the disclosure comprises a base compound, wherein the base compound comprises at least one first phase (i) comprising at least one poly(meth)acrylate, and at least one second phase (ii) comprising at least one vinylaromatic block copolymer such as styrene block copolymer in particular.

It already follows from the term “phases” that phases (i) and (ii) are present separately from one another side-by-side in the adhesive compound.

Poly(meth)acrylate and vinylaromatic block copolymer are respectively present in the adhesive compound of the disclosure in individual phases that surround one another.

In particular, the vinylaromatic block copolymer may be present here dispersed in the poly(meth)acrylate, thus forming domains in the poly(meth)acrylate matrix or, conversely, the poly(meth)acrylate may be dispersed in the vinylaromatic block copolymer, thus forming domains in the vinylaromatic block copolymer matrix. The above statements apply by analogy to the case where phase (i) comprises more than one poly(meth)acrylate, in particular two or more poly(meth)acrylates, and/or where phase (ii) comprises more than one vinylaromatic block copolymer, in particular two or more vinylaromatic block copolymers.

The poly(meth)acrylates and vinylaromatic block copolymers present in the adhesive compound are preferably selected such that they are not miscible with one another to homogeneity at 23° C. The adhesive compound of the disclosure is thus at least microscopically, and at least at room temperature, preferably present in an at least two-phase morphology. Particularly preferably, poly(meth)acrylate(s) and vinylaromatic block copolymer(s) are not homogeneously miscible with one another in a temperature range from 0° C. to 50° C., in particular from −30° C. to 80° C., so that the adhesive compound is in these temperature ranges present at least microscopically in at least two phases.

Components are defined for the purposes of this document as being “not homogeneously miscible with one another” when, even after intimate mixing, the formation of at least two stable phases can be detected at least microscopically physically and/or chemically, one phase being rich in one component and the second phase being rich in the other component. The presence of negligibly small amounts of one component in the other that does not hinder the development of polyphasicity is considered negligible here. For instance, it is possible for minor amounts of vinylaromatic block copolymer to be present in the poly(meth)acrylate phase and/or for minor amounts of poly(meth)acrylate to be present in the vinylaromatic block copolymer phase, provided these are not significant amounts that affect phase separation.

The phase separation can in particular be realized such that discrete regions (“domains”) that are rich in vinylaromatic block copolymer—i.e. formed essentially from vinylaromatic block copolymer—are present in a continuous matrix rich in poly(meth)acrylate—i.e. formed essentially from poly(meth)acrylate.

An example of a suitable analysis system for a phase separation is scanning electron microscopy. Phase separation can however also be recognized for example by the different phases having two independent glass transition temperatures in differential scanning calorimetry (DSC) or dynamic mechanical analysis (DMA). Phase separation is according to the disclosure present when it can be unambiguously demonstrated by at least one of the analysis methods.

Within the vinylaromatic block copolymer-rich domains, an additional polyphasicity may also be present as a fine structure, wherein the vinylaromatic block copolymer typically has A and B blocks and thus the A blocks form a first phase and the B blocks a second phase.

Preferably, phase (ii), and thus the vinylaromatic block copolymer(s) in the adhesive compound of the disclosure, is present in dispersed form in phase (i) and thus in the poly(meth)acrylate(s). Phases (i) and (ii) are accordingly themselves preferably homogeneous phases.

Preferably, phase (i) contains 60% to 99.5%, preferably 70% to 85%, by weight of poly(meth)acrylates based on the total weight of phase (i).

Preferably, phase (ii) contains 90% to 100% by weight of vinylaromatic block copolymers based on the total weight of phase (ii).

Preferably, the base compound contains 51% to 90% by weight, preferably 60% to 80% by weight, of phase (i), and 10% to 49% by weight, preferably 20% to 40% by weight, of phase (ii), the two weight fractions preferably adding up to 100%, this accordingly preferably meaning that other additives that are not dispersed in phases (i) and (ii) are absent.

This results in the object of the disclosure being particularly well achieved.

Preferably, the base compound contains 40% to 70% by weight, more preferably 45% to 60% by weight, of at least one poly(meth)acrylate in phase (i) and 15% to 50% by weight of at least one vinylaromatic block copolymer in phase (ii), in each case based on the total weight of the base compound.

With said preferred amounts of the polymers in the individual phases or of the total amount in the adhesive compound, the object of the disclosure is particularly well achieved.

A “poly(meth)acrylate” is understood as meaning a polymer obtainable preferably by free-radical polymerization of acrylic and/or methacrylic monomers and optionally other copolymerizable monomers. In particular, a “poly(meth)acrylate” is understood as meaning a polymer for which the monomer basis consists to an extent of at least 50% by weight of acrylic acid, methacrylic acid, acrylic esters and/or methacrylic esters, where acrylic esters and/or methacrylic esters are present in a proportion at least, preferably to an extent of at least 30% by weight based on the total monomer basis of the polymer concerned.

The glass transition temperature, determined by DSC, as described in the test method section under “DSC”, of the poly(meth)acrylate of the adhesive compound of the disclosure is preferably <0° C. (less than zero degrees Celsius), more preferably between −5 and −50° C. (between minus five degrees and minus fifty degrees Celsius).

This achieves particularly good flow-on behavior in the adhesive compound and good formulability, in particular through the addition of tackifier resins suitable in the particular case.

The glass transition temperature of the poly(meth)acrylate is determined predominantly through the choice of monomers.

Preferably, the poly(meth)acrylate of the adhesive compound comprises at least a proportion of functional monomers incorporated through polymerization, particularly preferably monomers of at least one type having at least one functional group selected from the group consisting of carboxylic acid groups, sulfonic acid groups, phosphonic acid groups, hydroxy groups, acid anhydride groups, epoxy groups, and amino groups.

Said functional groups, with the exception of epoxy groups, are reactive toward epoxy groups, thereby advantageously making the poly(meth)acrylate amenable to thermal crosslinking with introduced epoxides.

Very particularly preferably, the poly(meth)acrylate of the adhesive compound comprises at least a proportion of functional monomers incorporated through polymerization, particularly preferably monomers of at least one type having at least one functional group selected from the group consisting of carboxylic acid groups and epoxy groups; in particular, it contains at least one carboxylic acid group.

According to particularly advantageous embodiments, the poly(meth)acrylate of the adhesive compound contains a proportion of acrylic acid and/or methacrylic acid incorporated through polymerization. The carboxylic acid groups consequently make the poly(meth)acrylate reactive toward epoxy groups, thereby advantageously making the poly(meth)acrylate amenable to thermal crosslinking with introduced epoxides.

The poly(meth)acrylate of the adhesive compound can preferably be derived from the following monomer composition:
a) at least one acrylic ester and/or methacrylic ester of the following formula (1)

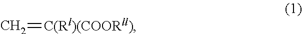

where R^{I}═H or CH₃ and R^{II} is an alkyl radical having 4 to 18 carbon atoms;
b) at least one olefinically unsaturated monomer having at least one functional group selected from the group consisting of carboxylic acid groups, sulfonic acid groups, phosphonic acid groups, hydroxy groups, acid anhydride groups, epoxy groups, and amino groups;
c) optionally further acrylic esters and/or methacrylic esters and/or olefinically unsaturated monomers copolymerizable with component (a).

According to advantageous embodiments, the poly(meth)acrylate is based on a monomer composition comprising the monomers of group a) in a proportion of from 25% to 99% by weight, more preferably 40% to 86% by weight, and monomers of group b) in a proportion of from 1% to 15% by weight, more preferably 1% to 7% by weight, and optionally monomers of group c) in a proportion of from 0% to 60% by weight, preferably in a proportion of from 15% to 53% by weight, the amounts stated being based on the monomer mixture for the polymer not including any additional additives such as resins, etc.

The presence of a poly(meth)acrylate of this kind in the adhesive compound achieves a particularly good property profile comprising stickiness, shear strengths, and residue-free detachability.

According to particularly advantageous embodiments of the disclosure, the poly(meth)acrylate is based on a monomer composition comprising the monomers of group a) in a proportion of from 40% to 60% by weight and monomers of group b) in a proportion of from 1% to 7% by weight and monomers of group c) in a proportion of from 33% to 53% by weight, the amounts stated being based on the monomer mixture for the polymer not including any additional additives such as resins, etc.

According to particularly advantageous embodiments of the disclosure, the poly(meth)acrylate is based on a monomer composition comprising the monomers of group a) in a proportion of from 50% to 86% by weight and monomers of group b) in a proportion of from 1% to 7% by weight and monomers of group c) in a proportion of from 13% to 43% by weight, the amounts stated being based on the monomer mixture for the polymer not including any additional additives such as resins, etc.

According to particularly advantageous embodiments of the disclosure, the poly(meth)acrylate is based on a monomer composition comprising the monomers of group a) in a proportion of from 50% to 65% by weight and monomers of group b) in a proportion of from 1% to 5% by weight and monomers of group c) in a proportion of from 34% to 45% by weight, the amounts stated being based on the monomer mixture for the polymer not including any additional additives such as resins, etc.

According to particularly advantageous embodiments of the disclosure, the poly(meth)acrylate is based on a monomer composition comprising the monomers of group a) in a proportion of from 75% to 86% by weight and monomers of group b) in a proportion of from 1% to 5% by weight and monomers of group c) in a proportion of from 13% to 20% by weight, the amounts stated being based on the monomer mixture for the polymer not including any additional additives such as resins, etc.

The monomers of component a) are generally plasticizing, comparatively nonpolar monomers. Particularly preferably, R^{II} in monomers a) is an alkyl radical having 4 to 10 carbon atoms. The monomers of formula (1) are in particular selected from the group consisting of n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, 2-ethylhexyl acrylate, 2-ethylhexyl methacrylate, 2-propylheptyl acrylate, and 2-propylheptyl methacrylate.

Particularly preferably, the monomers of formula (1)/group a) are selected from the group consisting of n-butyl acrylate, n-hexyl acrylate, n-octyl acrylate, isooctyl acrylate, 2-ethylhexyl acrylate, and 2-propyl heptyl acrylate.

The recited monomers are particularly readily polymerizable and the glass transition temperature of the poly(meth)acrylate produced particularly readily adjustable. This in turn makes it possible to achieve optimized properties with regard to flowability and stickiness that are also adjusted in line with the respective substrate or component to be bonded.

The monomers of formula (1)/group a) are even more preferably selected from the group consisting of n-butyl acrylate, isooctyl acrylate, and 2-ethylhexyl acrylate.

Very particular preference is given to using n-butyl acrylate and 2-ethylhexyl acrylate as monomers of formula (1)/group a).

According to particularly advantageous embodiments, n-butyl acrylate is used as monomer.

The monomers of group b) are particularly preferably selected from the group consisting of acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, 2-hydroxyethyl acrylate, hydroxypropyl acrylate, 3-hydroxypropyl acrylate, hydroxybutyl acrylate, 4-hydroxybutyl acrylate, hydroxyhexyl acrylate, 6-hydroxyhexyl acrylate, hydroxyethyl methacrylate, 2-hydroxyethyl methacrylate, hydroxypropyl methacrylate, 3-hydroxypropyl methacrylate, hydroxybutyl methacrylate, 4-hydroxybutyl methacrylate, hydroxyhexyl methacrylate, 6-hydroxyhexyl methacrylate, allyl alcohol, glycidyl acrylate, and glycidyl methacrylate.

Very particular preference is given to using acrylic acid as monomers of group b).

Examples of monomers of component c) are: methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, t-butylphenyl acrylate, t-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, methyl 3-methoxyacrylate, 3-methoxybutyl acrylate, 2-phenoxyethyl methacrylate, butyl diglycol methacrylate, ethylene glycol acrylate, ethylene glycol monomethyl acrylate, methoxy polyethylene glycol methacrylate 350, methoxy polyethylene glycol methacrylate 500, propylene glycol monomethacrylate, butoxy diethylene glycol methacrylate, ethoxy triethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylaminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, N,N-dialkyl-substituted amides, for example N,N-dimethylacrylamide and N,N-dimethylmethacrylamide, N-benzylacrylamide, N-isopropylacrylamide, N-tert-butylacrylamide, N-tert-octylacrylamide, N-methylolacrylamide, N-methylolmethacrylamide, acrylonitrile, methacrylonitrile, vinyl ethers such as vinyl methyl ether, ethyl vinyl ether, vinyl isobutyl ether, vinyl esters such as vinyl acetate, vinyl halides, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene, macromonomers such as 2-polystyreneethyl methacrylate (weight-average molecular weight Mw, determined by GPC, of 4000 to 13 000 g/mol), poly(methyl methacrylate)ethyl methacrylate (Mw of 2000 to 8000 g/mol).

Monomers of component c) may advantageously also be chosen such that they contain functional groups that assist subsequent radiochemical crosslinking (for example by electron beams or UV irradiation). Suitable copolymerizable photoinitiators are for example benzoin acrylate and acrylate-functionalized benzophenone derivatives. Monomers that assist crosslinking by electron bombardment are for example tetrahydrofurfuryl acrylate and allyl acrylate.

Preferably, the monomers of group c) are selected from methyl acrylate and benzyl acrylate.

According to preferred embodiments of the disclosure, the monomers of group c) are selected from methyl acrylate and benzyl acrylate and also from polar monomers, preferably nitrogen-containing monomers.

Preferably, the poly(meth)acrylate is a polyacrylate produced by polymerization of n-butyl acrylate and/or 2-ethylhexyl acrylate and/or methyl acrylate and/or benzyl (meth)acrylate and acrylic acid.

According to particularly preferred embodiments, the poly(meth)acrylate is a polyacrylate produced by polymerization of n-butyl acrylate, methyl acrylate, benzyl acrylate and acrylic acid. Preferably, the corresponding monomer composition on which the abovementioned poly(meth)acrylate is based contains n-butyl acrylate in a proportion of from 40% to 65% by weight and acrylic acid in a proportion of from 1% to 5% by weight, and methyl acrylate and benzyl acrylate in a combined proportion of from 34% to 55% by weight, the proportion of methyl acrylate and benzyl acrylate preferably being 1.5:1 to 1:1.5, in particular 1:1.

As a result, the adhesive tape of the disclosure has a particularly high strength of adhesion as well as high shear strengths and can at the same time be detached without leaving residues.

According to further preferred embodiments, the monomer composition also comprises a polar monomer, which is preferably at least one nitrogen-containing monomer.

A “nitrogen-containing monomer” is understood here as meaning a chemical compound bearing at least one functional group that includes at least one nitrogen atom.

Preferably, the nitrogen-containing monomer or at least one of the nitrogen-containing monomers of the monomer composition is selected from the group consisting of nitrogen-containing (meth)acrylate monomers, vinylpyridine, 4-vinylpyridine, N-vinylphthalimide, N-vinyllactam, N-vinylpyrrolidone, and N-vinylformamide.

Preference is given to nitrogen-containing (meth)acrylate monomers. The nitrogen-containing monomer or at least one of the nitrogen-containing monomers of the monomer composition is thus preferably a nitrogen-containing (meth)acrylate monomer.

A “nitrogen-containing (meth)acrylate monomer” is understood here as meaning a chemical compound bearing at least one methacrylate or at least one acrylate function and additionally a functional group that includes at least one nitrogen atom.

According to preferred embodiments of the disclosure, the nitrogen-containing (meth)acrylate monomer or at least one of the nitrogen-containing (meth)acrylate monomers of the monomer composition is selected from the group consisting of (meth)acrylamides, substituted (meth)acrylamides, amino(meth)acrylates, substituted amino(meth)acrylates, (meth)acrylonitrile, cyanoalkyl(meth)acrylates, and 4-(meth)acryloyloxymorpholine.

According to preferred embodiments of the disclosure, the nitrogen-containing (meth)acrylate monomer or at least one of the nitrogen-containing (meth)acrylate monomers of the monomer composition is selected from the group consisting of cyanoethyl acrylate, cyanoethyl methacrylate, diethylaminoethyl acrylate, diethylaminoethyl methacrylate, dimethylaminoethyl acrylate, dimethylaminoethyl methacrylate, dimethylaminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide; N,N-dialkyl-substituted amides, for example N,N-dimethylacrylamide, N,N-dimethylmethacrylamide, N,N-diethylacrylamide and N,N-diethylmethacrylamide, N-benzylacrylamide, N-isopropylacrylamide, N-tert-butylacrylamide, N-tert-octylacrylamide, N-methylolacrylamide, N-methylolmethacrylamide, 4-(meth)acryloyloxymorpholine, acrylonitrile, and methacrylonitrile.

According to particularly advantageous embodiments, the monomer composition contains more than 15% by weight of at least one acrylamide as nitrogen-containing (meth)acrylate monomer, the acrylamide preferably being selected from the group consisting of dimethylaminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, N,N-dialkyl-substituted amides, for example N,N-dimethylacrylamide, N,N-dimethylmethacrylamide, N,N-diethylacrylamide and N,N-diethylmethacrylamide, N-benzylacrylamide, N-isopropylacrylamide, N-tert-butylacrylamide, N-tert-octylacrylamide, N-methylolacrylamide, and N-methylolmethacrylamide.

Very particularly preferably, at least one substituted acrylamide is present as nitrogen-containing (meth)acrylate monomer, this being selected from the group consisting of N,N-dimethylacrylamide (NNDMA) and N,N-diethylacrylamide (NNDEA).

According to particularly advantageous embodiments, the monomer composition contains more than 15% by weight of the nitrogen-containing (meth)acrylate monomer N,N-dimethylacrylamide.

Particularly preferably, the poly(meth)acrylate is a polyacrylate produced by polymerization of n-butyl acrylate and/or 2-ethylhexyl acrylate and/or methyl acrylate and/or benzyl (meth)acrylate and acrylic acid and at least one nitrogen-containing monomer, preferably N,N-dimethylacrylamide.

According to particularly preferred embodiments, the poly(meth)acrylate is a polyacrylate produced by polymerization of n-butyl acrylate, 2-ethylhexyl acrylate, N,N-dimethylacrylamide, and acrylic acid. Preferably, the corresponding monomer composition on which the abovementioned poly(meth)acrylate is based contains N-butyl acrylate in a proportion of from 40% to 65% by weight and acrylic acid in a proportion of from 1% to 5% by weight and N,N-dimethylacrylamide in a proportion of from 10% to 25% by weight, preferably 15 to 25% by weight, and 2-ethylhexyl acrylate in a proportion of from 20% to 35% by weight.

As a result, the adhesive tape of the disclosure has a particularly high strength of adhesion as well as high shear strengths and can at the same time be detached without leaving residues.

The poly(meth)acrylates are preferably produced by conventional free-radical polymerizations or controlled free-radical polymerizations. The poly(meth)acrylates can be produced by copolymerization of the monomers using customary polymerization initiators and optionally chain transfer agents, with polymerization at the usual temperatures in bulk, in emulsion, for example in water or liquid hydrocarbons, or in solution.

The poly(meth)acrylates are produced preferably by copolymerization of the monomers in solvents, more preferably in solvents having a boiling range of 50 to 150° C., in particular from 60 to 120° C., using from 0.01% to 5% by weight, in particular from 0.1% to 2% by weight, in each case based on the total weight of the monomers, of polymerization initiators.

In principle, all customary initiators are suitable. Examples of free radical sources are peroxides, hydroperoxides, and azo compounds, for example dibenzoyl peroxide, cumene hydroperoxide, cyclohexanone peroxide, di-t-butyl peroxide, cyclohexylsulfonyl acetyl peroxide, diisopropyl percarbonate, t-butyl peroctoate, and benzopinacol. Preferred free radical initiators are 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont).

Preferred solvents for the production of the poly(meth)acrylates are alcohols such as methanol, ethanol, n-propanol, isopropanol, n-butanol, and isobutanol, in particular isopropanol and/or isobutanol; hydrocarbons such as toluene and in particular petrols having a boiling range of from 60 to 120° C.; ketones, in particular acetone, methyl ethyl ketone, methyl isobutyl ketone; esters such as ethyl acetate, and mixtures of the abovementioned solvents. Particularly preferred solvents are mixtures containing isopropanol in amounts of from 2% to 15% by weight, in particular from 3% to 10% by weight, in each case based on the solvent mixture used.

It is preferable that the production (polymerization) of the poly(meth)acrylates is followed by a concentration step, and that the further processing of the poly(meth)acrylates is essentially carried out solvent-free. The concentration of the polymer can take place in the absence of crosslinker and accelerator substances. However, it is also possible to add a compound from one of these classes to the polymerization product prior to concentration, so that the concentration then takes place in the presence of said substance(s).

The polymerization products can be transferred to a compounder after the concentration step. It is also optionally possible for the concentration and compounding to take place in the same reactor.

The weight-average molecular weight MW of the poly(meth)acrylate is preferably within a range of from 20 000 to 2 000 000 g/mol, particularly preferably within a range of from 100 000 to 1 500 000 g/mol, very particularly preferably within a range of from 150 000 to 1 200 000 g/mol. For this, it may be advantageous to carry out the polymerization in the presence of suitable polymerization chain transfer agents such as thiols, halogen compounds and/or alcohols in order to adjust the desired average molecular weight.

Preference is thus given to an adhesive compound in which the poly(meth)acrylate has a weight-average molecular weight MW of from 20 000 to 2 000 000 g/mol, particularly preferably from 100 000 to 1 500 000 g/mol, very particularly preferably from 150 000 to 1 200 000 g/mol.

According to preferred embodiments of the disclosure, the poly(meth)acrylate has a MW of 600 000 to 1 200 000 g/mol, in particular 700 000 to 900 000 g/mol.

The poly(meth)acrylates preferably have a K value of from 30 to 90, more preferably from 40 to 80, measured in toluene (1% solution, 21° C.). The Fikentscher K value is a measure of the molecular weight and viscosity of polymers.

Preferably, the poly(meth)acrylate of the adhesive compound of the disclosure has a polydispersity PD of <4 and thus a relatively narrow molecular weight distribution. Compounds based thereon have particularly good shear strength after crosslinking despite a relatively low molecular weight. Moreover, the relatively low polydispersity allows easier processing from the melt, since the flow viscosity is lower compared to a poly(meth)acrylate having a broader distribution, while retaining largely identical use properties. Poly(meth)acrylates having a narrow distribution can advantageously be produced by anionic polymerization or by controlled free-radical polymerization methods, the latter being particularly suitable. Corresponding poly(meth)acrylates can also be produced via N-oxyls. It is also advantageously possible to employ atom-transfer radical polymerization (ATRP) for the synthesis of poly(meth)acrylates having a narrow distribution, the initiators used preferably being monofunctional or difunctional secondary or tertiary halides, the halide(s) being abstracted using complexes of Cu, Ni, Fe, Pd, Pt, Ru, Os, Rh, Co, Ir, Ag or Au. RAFT polymerization is also suitable.

The poly(meth)acrylates of the adhesive compound of the disclosure are preferably crosslinked with thermal crosslinkers by means of coupling reactions—particularly in the sense of addition or substitution reactions—of functional groups present therein. All thermal crosslinkers may be used that
both ensure a sufficiently long processing time so that no gelation occurs during the processing process, particularly the extrusion process,
and result in rapid post-crosslinking of the polymer to the desired degree of crosslinking at temperatures lower than the processing temperature, in particular at room temperature.

For example, it is possible to use as crosslinker a combination of polymers and isocyanates containing carboxy, amino and/or hydroxy groups, in particular aliphatic or blocked isocyanates, for example trimerized isocyanates deactivated with amines. Suitable isocyanates are in particular trimerized derivatives of MDI [4,4-methylenedi(phenyl isocyanate)], HDI [hexamethylene diisocyanate, 1,6-hexylene diisocyanate], and IPDI [isophorone diisocyanate, 5-isocyanato-1-isocyanatomethyl-1,3,3-trimethylcyclohexane], for example the products Desmodur® N3600 and XP2410 (both from Bayer AG: aliphatic polyisocyanates, low-viscosity HDI trimers). Also suitable is the surface-deactivated dispersion of micronized, trimerized IPDI BUEJ 339@, now HF9 ® (Bayer AG).

Preference is also given to crosslinking via complexing agents, also referred to as chelates. A preferred complexing agent is for example aluminium acetylacetonate, which is obtainable for example under the trade name Catana™ CAA 2072 from Sachen.

Preferably, the poly(meth)acrylates in the adhesive compound of the disclosure are crosslinked using epoxides or using one or more substances containing epoxy groups. Substances containing epoxy groups are in particular polyfunctional epoxides, i.e. ones having at least two epoxy groups; this accordingly results overall in an indirect coupling of the structural units of the poly(meth)acrylates bearing the functional groups. The substances containing epoxy groups may be either aromatic or aliphatic compounds.

Exceptionally suitable polyfunctional epoxides are oligomers of epichlorohydrin, epoxy ethers of polyhydric alcohols, in particular ethylene glycol, propylene glycol, and butylene glycol, polyglycols, thiodiglycols, glycerol, pentaerythritol, sorbitol, polyvinyl alcohol, polyallyl alcohol, and the like; epoxy ethers of polyhydric phenols, in particular resorcinol, hydroquinone, bis(4-hydroxyphenyl)methane, bis(4-hydroxy-3-methylphenyl)methane, bis(4-hydroxy-3,5-dibromophenyl)methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)-propane, 2,2-bis(4-hydroxy-3,5-dichlorophenyl)propane, 2,2-bis(4-hydroxy-3,5-dichlorophenyl)propane, bis(4-hydroxyphenyl)phenylmethane, bis(4-hydroxyphenyl)phenylmethane, bis(4-hydroxyphenyl)diphenylmethane, bis(4-hydroxyphenyl)-4′-methylphenylmethane, 1,1-bis(4-hydroxyphenyl)-2,2,2-trichloroethane, bis(4-hydroxyphenyl)-(4-chlorophenyl)methane, 1,1-bis(4-hydroxyphenyl)-cyclohexane, bis(4-hydroxyphenyl)cyclohexylmethane, 4,4′-dihydroxydiphenyl, 2,2′-dihydroxydiphenyl, 4,4′-dihydroxydiphenylsulfone, and hydroxyethyl ethers thereof; phenol-formaldehyde condensation products such as phenol-alcohols and phenol-aldehyde resins; epoxides containing S and N, for example N,N-diglycidylaniline and N,N′-dimethyldiglycidyl-4,4-diaminodiphenylmethane, and epoxides prepared from polyunsaturated carboxylic acids or monounsaturated carboxylic esters by standard methods; glycidyl esters; polyglycidyl esters that can be obtained by polymerization or copolymerization of glycidyl esters of unsaturated acids or obtainable from other acidic compounds, for example from cyanuric acid, diglycidyl sulfide or cyclic trimethylene trisulfone or derivatives thereof.

Very suitable ethers are for example butane-1,4-diol diglycidyl ether, polyglycerol-3 glycidyl ether, cyclohexanedimethanol diglycidyl ether, glycerol triglycidyl ether, neopentyl glycol diglycidyl ether, pentaerythritol tetraglycidyl ether, hexane-1,6-diol diglycidyl ether, polypropylene glycol diglycidyl ether, trimethylolpropane triglycidyl ether, pentaerythritol tetraglycidyl ether, bisphenol A diglycidyl ether, and bisphenol F diglycidyl ether.

Other preferred epoxides are cycloaliphatic epoxides, such as 3,4-epoxycyclohexylmethyl 3,4-epoxycyclohexanecarboxylate, which is commercially available under the trade name Uvacure® 1500 from Syensqo.

Further preferred epoxides are epoxy-functional organoalkoxysilanes and in particular cycloaliphatic epoxysilanes selected from the group consisting of (3-glycidyloxypropyl)trimethoxysilane (CAS No. 2530-83-8, for example Dynasylan® GLYMO, Evonik), (3-glycidyloxypropyl)triethoxysilane (CAS No. 2602-34-8, for example Dynasylan® GLYEO, Evonik), (3-glycidyloxypropyl)methyldimethoxysilane (CAS No. 65799-47-5, for example Gelest Inc.), (3-glycidyloxypropyl)methyldiethoxysilane (CAS No. 2897-60-1, for example Gelest Inc.), 5,6-epoxyhexyltriethoxysilane (CAS No. 86138-01-4, for example Gelest Inc.), 2-(3,4-epoxycyclohexyl)ethyl]trimethoxysilane (CAS No. 3388-04-3, for example Sigma-Aldrich), 2-(3,4-epoxycyclohexyl)ethyl]triethoxysilane (CAS No. 10217-34-2, for example ABCR GmbH), and triethoxy[3-[(3-ethyl-3-oxetanyl)methoxy]propyl]silane (CAS No. 220520-33-2, for example Aron Oxetane OXT-610, Toagosei Co., Ltd.). According to preferred embodiments, (3-glycidyloxypropyl)triethoxysilane is used.

Preferably, the crosslinker(s) is/are used to a total extent of from 0.1% to 5% by weight, in particular to an extent of from 0.2% to 1% by weight, based on the total weight of the polymer to be crosslinked.

The amount of the crosslinker(s) is not defined as part of the base compound, but is added to this in addition.

Particularly preferably, the poly(meth)acrylates are crosslinked by means of a crosslinker accelerator system (“crosslinking system”) so as to obtain better control over the processing time, the crosslinking kinetics, and the degree of crosslinking. The crosslinker accelerator system preferably comprises at least one epoxy-group-containing substance as crosslinker and at least one substance as accelerator that has an accelerator effect on crosslinking reactions using epoxy-group-containing substances at a temperature below the melting temperature of the polymer to be crosslinked.

The epoxy-group-containing substance serving as crosslinker comprises preferably and in particular the abovementioned epoxy-group-containing substances, to which all the above statements apply.

Particular preference in accordance with the disclosure is given to using amines as accelerators. These are to be formally understood as substitution products of ammonia; in the following formulas, the substituents are represented by “R” and encompass in particular alkyl and/or aryl radicals. Particular preference is given to those amines that do not react with the polymers to be crosslinked or react only negligibly.

In principle, primary (NRH₂), secondary (NR₂H), and tertiary amines (NR₃) can all be chosen as accelerators, including of course ones having a plurality of primary and/or secondary and/or tertiary amino groups. Particularly preferred accelerators are tertiary amines such as triethylamine, triethylenediamine, benzyldimethylamine, dimethylaminomethylphenol, 2,4,6-tris(N,N-dimethylaminomethyl)phenol, and N,N′-bis(3-(dimethylamino)propyl)urea. Other preferred accelerators are polyfunctional amines such as diamines, triamines, and/or tetramines, for example diethylenetriamine, triethylenetetramine, and trimethylhexamethylenediamine.

Other preferred accelerators are organosilanes containing at least one amino group and at least one alkoxy or acyloxy group. These allow the product properties to be refined still further. In particular and preferably, the accelerator selected here is at least one corresponding organosilane from the group consisting of N-cyclohexyl-3-aminopropyltrimethoxysilane (CAS No. 3068-78-8), N-cyclohexylaminomethyltriethoxysilane (CAS No. 26495-91-0), 3-aminopropyltrimethoxysilane (CAS No. 13822-56-5), 3-aminopropyltriethoxysilane (CAS No. 919-30-2), 3-aminopropylmethyldiethoxysilane (CAS No. 3179-76-8), 3-(2-aminomethylamino)propyltriethoxysilane (CAS No. 5089-72-5), 3-(N,N-dimethylaminopropyl)trimethoxysilane (CAS No. 2530-86-1), and bis(2-hydroxyethyl)-3-aminopropyltriethoxysilane (CAS No. 7538-44-5).

Particular preference is given to 3-aminopropyltriethoxysilane (CAS No. 919-30-2) and/or 3-aminopropylmethyldiethoxysilane (CAS No. 3179-76-8).

Other preferred accelerators are aminoalcohols, in particular secondary and/or tertiary aminoalcohols; where there is more than one amino functionality per molecule, it is preferable that at least one, more preferably all, amino functionalities are secondary and/or tertiary. Particularly preferred as accelerators of this kind are triethanolamine, N,N-bis(2-hydroxypropyl)ethanolamine, N-methyldiethanolamine, N-ethyldiethanolamine, 2-aminocyclohexanol, bis(2-hydroxycyclohexyl)methylamine, 2-(diisopropylamino)ethanol, 2-(dibutylamino)ethanol, N-butyldiethanolamine, N-butylethanolamine, 2-[bis(2-hydroxyethyl)amino]-2-(hydroxymethyl)-propane-1,3-diol, 1-[bis(2-hydroxyethyl)amino]-2-propanol, triisopropanolamine, 2-(dimethylamino)ethanol, 2-(diethylamino)ethanol, 2-(2-dimethylaminoethoxy)ethanol, N,N,N′-trimethyl-N’-hydroxyethylbisaminoethyl ether, N,N,N′-trimethylaminoethylethanolamine, and N,N,N′-trimethylaminopropylethanolamine.

Other suitable accelerators are pyridine, imidazoles, for example 2-methylimidazole, and 1,8-diazabicyclo[5.4.0]undec-7-ene. It is also possible to use cycloaliphatic polyamines as accelerators. Also suitable are phosphorus-based accelerators such as phosphines and/or phosphonium compounds, for example triphenylphosphine or tetraphenylphosphonium tetraphenylborate.

It is also possible to use quaternary ammonium compounds as accelerators; examples are tetrabutylammonium hydroxide, cetyltrimethylammonium bromide, and benzalkonium chloride.

Preferably, such accelerators are used to an extent of from 0.1% to 5% by weight, in particular to an extent of from 0.2% to 1% by weight, based on the total weight of the polymer to be crosslinked. The amount of the accelerator is not defined as part of the base compound, but is added to this in addition.

The vinylaromatic block copolymer(s) may in principle be of any type known to those skilled in the art.

The vinylaromatic block copolymers preferably have the construction A-B, A-B-A, (A-B)ₙ, (A-B)ₙX or (A-B-A)ₙX,
wherein
   the A blocks are each independently a polymer formed by polymerization of at least one vinylaromatic;
   the B blocks are each independently a polymer formed by polymerization of conjugated dienes having 4 to 18 carbon atoms and/or isobutylene, or a partly or fully hydrogenated derivative of such a polymer;
   X is the radical of a coupling reagent or initiator and
   n is an integer ≥2.

Suitable coupling reagents and initiators are known to those skilled in the art.

More particularly, all vinylaromatic block copolymers in the adhesive compound of the disclosure are block copolymers having a construction as detailed above. The adhesive compound of the disclosure may thus also comprise mixtures of different block copolymers having a construction as above.

Preferred vinylaromatic block copolymers thus include one or more rubber-like blocks B (soft blocks) and one or more glass-like blocks A (hard blocks). Particularly preferably, the at least one vinylaromatic block copolymer in the adhesive compound of the disclosure is a block copolymer having an A-B, A-B-A, (A-B)₃X, or (A-B)₄X construction, where A, B, and X are as defined above. Very particularly preferably, all vinylaromatic block copolymers in the adhesive compound of the disclosure are block copolymers having an A-B, A-B-A, (A-B)₃X or (A-B)₄X construction, where A, B, and X are as defined above. In particular, the at least one vinylaromatic block copolymer in the adhesive compound of the disclosure is a mixture of block copolymers having an A-B, A-B-A, (A-B)₃X or (A-B)₄X construction, preferably comprising at least diblock copolymers A-B and/or triblock copolymers A-B-A.

The block copolymers that result from the A and B blocks may comprise identical or different B blocks.

According to preferred embodiments, the block copolymers have linear A-B-A structures as described.

According to further embodiments, preference is given to block copolymers of radial form, i.e. (A-B)₃X or (A-B)₄X.

According to preferred embodiments, A-B two-block copolymers are present as further components.

All the aforementioned polymers can be utilized alone or in a mixture with one another.

The A block is in particular a glass-like block having a preferred glass transition temperature (T_{g}) that is above room temperature. Particularly preferably, the Tg of the glass-like block is at least 40° C., in particular at least 60° C., very particularly preferably at least 80° C., and most preferably at least 100° C. The proportion of vinylaromatic blocks A in the totality of the block copolymers is preferably 10% to 40% by weight, more preferably 10% to 20% by weight. Vinylaromatics for formation of the A block preferably include styrene and α-methylstyrene. The A block may thus be in the form of a homo- or copolymer.

Particularly preferably, the A block is a polystyrene.

The at least one vinylaromatic block copolymer is preferably at least one styrene block copolymer.

The block B is in particular a rubber-like block or soft block having a Tg of preferably below room temperature. The Tg of the soft block is particularly preferably less than 0° C., in particular less than −10° C., for example less than −40° C., and very particularly preferably less than −60° C.

Preferred conjugated dienes as monomers for the soft block B are selected in particular from the group consisting of butadiene, isoprene, ethylbutadiene, phenylbutadiene, piperylene, pentadiene, hexadiene, ethylhexadiene, dimethylbutadiene, and farnesene isomers and any desired mixtures of these monomers. The B block may also be in the form of a homopolymer or copolymer.

Particularly preferably, the conjugated dienes as monomers for the soft block B are selected from butadiene and isoprene. For example, the soft block B is a polyisoprene, a polybutadiene or a partly or fully hydrogenated derivative of one of these two polymers, such as in particular polybutylene-butadiene, or a polymer formed from a mixture of butadiene and isoprene. Very particularly preferably, the B block is a polyisoprene.

Particularly with polyisoprene as B block, the adhesive compound has high shear strength.

According to particularly preferred embodiments, the at least one polyvinylaromatic-polydiene block copolymer is a styrene-butadiene-styrene block copolymer (SBS) or a styrene-isoprene-styrene block copolymer (SIS), in particular a styrene-isoprene-styrene block copolymer (SIS).

A suitable styrene-isoprene-styrene block copolymer (SIS) comprising linear styrene-isoprene-styrene structures is for example available under the trade name Europrene® SOL T 190 from Versalis.

According to preferred embodiments, the adhesive compound of the disclosure includes at least one tackifier resin in the base compound.

A “tackifier resin”, according to the general understanding of those skilled in the art, is understood as meaning an oligomeric or polymeric resin that increases adhesion (strength of adhesion) of the adhesive compound compared to an adhesive compound that does not contain any tackifier resin but is otherwise identical.

According to preferred embodiments, the tackifier resin is present in phase (i) and is thus a tackifier resin compatible with the at least one poly(meth)acrylate.

A “tackifier resin compatible with the poly(meth)acrylate” is understood as meaning a tackifier resin that alters the glass transition temperature of the system obtained after thorough mixing of poly(meth)acrylate and tackifier resin compared to the pure poly(meth)acrylate, in addition only one Tg can be ascribed to the mixture of poly(meth)acrylate and tackifier resin. A tackifier resin incompatible with the poly(meth)acrylate would result in the system obtained after thorough mixing of poly(meth)acrylate and tackifier resin having two glass transition temperatures (Tg), one of which being due to the poly(meth)acrylate and the other to the resin domains. The Tg is in this context determined calorimetrically by DSC (differential scanning calorimetry).

The tackifier resin compatible with the poly(meth)acrylate preferably has a DACP value of less than 0° C., very preferably of at most −20° C., and/or preferably an MMAP value of less than 40° C., very preferably of at most 30° C.

Particularly preferably, the tackifier resin compatible with the poly(meth)acrylate is selected from the group consisting of rosin derivatives, in particular rosin esters, (meth)acrylate resins, and terpene-phenol resins.

Particular preference is given to a (meth)acrylate resin. This can in particular improve adhesion to polar bonding substrates. An adhesive compound of the disclosure may also contain mixtures of more than one tackifier resin. A suitable resin is available under the trade name Paraloid™ DM-55 from Dow.

The total amount of tackifier resins in the base compound is preferably from 5% to 20% by weight, particularly preferably from 10% to 20% by weight.

Within the stated ranges for the total amount of tackifier resins, the adhesive compound has very good shear strengths and at the same time an attractive strength of adhesion, while still having electrical redetachability, the adhesive compound having been accordingly optimized further in respect of the conflicting aims regarding strength of adhesion, shear strength, and redetachability in the amount ranges resulting from the chosen lower limits and upper limits of higher levels of preference.

According to further preferred embodiments, the adhesive compound of the disclosure does not include a tackifier resin, i.e. neither in the base compound nor additionally. According to these embodiments, preference is given to crosslinking via complexing agents such as aluminum acetylacetonate.

The base compound of the adhesive compound of the disclosure may in addition to the recited constituents comprise further constituents.

Particularly preferably, the base compound comprises in addition at least one filler.

According to preferred embodiments of the disclosure, the amount of fillers present is from 0.3% to 5% by weight, preferably 0.5% to 2% by weight, as part of the base compound, i.e. based on the total weight of the base compound.

According to preferred embodiments, the filler is selected from the group consisting of microballoons.

“Microballoons” are understood as meaning hollow microbeads that are elastic and hence expandable in their ground state and have a thermoplastic polymer shell. These beads have been filled with low-boiling liquids or liquefied gas. Shell material employed is especially polyacrylonitrile, PVDC, PVC or polyacrylates. Suitable low-boiling liquids or gas are in particular hydrocarbons of the lower alkanes, for example isobutane or isopentane, that are enclosed in the polymer shell under pressure in the form of liquefied gas, isopentane being particularly preferred.

An action on the microballoons, particularly through the action of heat, results in softening of the outer polymer shell. At the same time, the liquid propellant gas present within the shell passes into its gaseous state. This causes irreversible extension and three-dimensional expansion of the microballoons. The expansion has ended when the internal and external pressure are equalized. Since the polymer shell is conserved, what is achieved is thus a closed-cell foam.

A multitude of microballoon types are commercially available, which differ essentially in their size (diameter 6 to 45 μm in the unexpanded state) and the starting temperatures that they require for expansion (75 to 220° C.). An example of commercially available microballoons is the Expancel® DU types (DU=dry unexpanded) from Nuryon and the Microsphere® FN types from Matsumoto.

A distinction can also be made between expandable, and thus still unexpanded, microballoons and ones that are pre-expanded.

In the context of the present disclosure, the use of unexpanded and/or pre-expanded microballoons is conceivable in principle.

Unexpanded microballoons are here usually added to a compound in the unexpanded state, and only then does expansion occur, in particular by heating.

Unexpanded microballoon products are also available in the form of an aqueous dispersion having a solids/microballoon content of approx. 40% to 45% by weight, and additionally also in the form of polymer-bound microballoons (masterbatches), for example in ethylene-vinyl acetate having a microballoon concentration of approx. 65% by weight. Both the microballoon dispersions and the masterbatches are, like the DU products, suitable for production of a foamed adhesive compound.

According to advantageous embodiments, the microballoons are expandable and are used unexpanded in the adhesive compound. It is further preferable here that the microballoons are neither expanded in the adhesive compound nor in the adhesive compound layer in the adhesive tape of the disclosure correspondingly formed therefrom. The adhesive tape of the disclosure thus preferably comprises unexpanded microballoons in the electrically detachable adhesive compound layer.

The microballoons commonly have an inorganic layer on their surface for stabilization. This can be for example a silicate or an aluminosilicate. However, carbonates such as calcium carbonate can also be used, or various oxides.

In the context of the present disclosure it has surprisingly been found that, preferably when using unexpanded microballoons having a layer of magnesium hydroxide (Mg(OH)₂) on their surface, an electrically detachable adhesive compound that contains electrolytes for this purpose is obtained that has good strength of adhesion and good shear strengths and at the same time has high corrosion resistance.

Preferably, the adhesive compound accordingly comprises in the base compound at least one filler selected from the group consisting of unexpanded microballoons having a layer of magnesium hydroxide (Mg(OH)₂) on their surface.

The adhesive tape of the disclosure thus preferably comprises in the electrically detachable adhesive compound layer unexpanded microballoons having a layer of magnesium hydroxide (Mg(OH)₂) on their surface.

According to preferred embodiments of the disclosure, the amount of unexpanded microballoons having a layer of magnesium hydroxide (Mg(OH)₂) on their surface is from 0.3% to 5% by weight, particularly preferably 0.5% to 2% by weight, as part of the base compound, i.e. based on the total weight of the base compound.

According to other preferred embodiments, the filler is magnesium hydroxide.

For adjustment of further properties, the base compound may comprise further additives. However, they are preferably present in a proportion of not more than 18% by weight of the base compound, preferably not more than 10% by weight.

These additives are primarily protective agents. These include ageing inhibitors of primary and secondary types, light stabilizers, and UV protectants, and also flame retardants, and additionally dyes and pigments. The adhesive compound layer may accordingly be colored any desired color or may be white, gray, or black. Further additives of this kind, or others, that can typically be utilized are:
primary antioxidants, for example sterically hindered phenols, preferably in a proportion of 0.2% to 1% by weight based on the total weight of the base compound,
secondary antioxidants, for example phosphites or thioethers, preferably in a proportion of 0.2% to 1% by weight based on the total weight of the base compound,
process stabilizers for example carbon radical scavengers, preferably in a proportion of 0.2% to 1% by weight based on the total weight of the base compound,
light stabilizers for example UV absorbers or sterically hindered amines, preferably in a proportion of 0.2% to 1% by weight based on the total weight of the base compound,
processing aids, preferably in a proportion of 0.2% to 1% by weight based on the total weight of the base compound, and
optionally further polymers of preferably elastomeric nature; elastomers utilizable accordingly include inter alia ones based on pure hydrocarbons, for example unsaturated polydienes such as natural or synthetically produced polyisoprene or polybutadiene, chemically substantially saturated elastomers, for example saturated ethylene-propylene copolymers, olefin copolymers, polyisobutylene, butyl rubber, ethylene-propylene rubber, and chemically functionalized hydrocarbons, for example halogenated, acrylate-containing, allyl-ether-containing or vinyl-ether-containing polyolefins, preferably in a proportion of 0.2% to 10% by weight based on the total weight of the base compound.

Where the adhesive compound comes into contact with a layer from which so-called rubber toxins, such as copper, manganese(II), iron(II), cobalt or nickel ions, can potentially be released, it is advantageous to add at least one type of metal deactivator, also termed a metal scavenger. Specific examples are ADK-Stab CDA-1, CDA-1H, CDA-6, and CDA-10 and also ADK-Stab ZS-27 or ZS-90 from Adeka, Hostanox OSP1 from Clariant, Naugard XL-1 from SIGroup, and Irganox MD-1024 from BASF. Amounts used are typically up to 0.5% by weight based on the base compound.

According to preferred embodiments, the adhesive compound of the disclosure comprises in the base compound at least one compatibilizer selected for example from the group consisting of polyethers, polyamines, polyvinylpyrrolidones or aliphatic polyesters, the compatibilizer preferably having a weight-average molecular weight (Mw) distribution of from 100 to 5000 g/mol, more preferably from 200 to 2000 g/mol. In addition, amphoteric substances such as alkali metal or alkaline earth fat soaps or anionic, cationic or nonionic surfactants are advantageously employable.

According to particularly preferred embodiments, the adhesive compound of the disclosure comprises as compatibilizer at least one polyether, preferably at least one substance selected from the group consisting of polyethylene glycol (PEG), polypropylene glycol (PPG), polytetrahydrofuran, with particular preference given to PEG and PPG. Block copolymers composed of PEG and PPG are also conceivable, as are polyethers bearing hydrocarbon segments.

The recited substances surprisingly achieve particularly good redetachability. Without wishing to be bound to a particular theory, it is conceivable that the ion flow of the electrolyte(s) through the layer of the compound is accelerated by the recited substances, in particular and for example PEG and/or PPG.

The total amount of compatibilizers in the adhesive compound is according to preferred embodiments in which at least one compatibilizer is present from 1% to 10% by weight, preferably 1% to 5% by weight, based on the total weight of the base compound.

This further optimizes the adhesive compound in respect of the conflicting aims regarding strength of adhesion and electrical redetachability.

Preferably, the adhesive compound of the disclosure contains 80% to 97.5% by weight, particularly preferably 85% to 95% by weight, very particularly preferably 85% to 92% by weight, of the base compound, in each case based on the total mass of the adhesive compound.

According to a particularly preferred embodiment of the disclosure, the adhesive compound of the disclosure contains the base compound described above, inclusive of all embodiments or levels of preference, preferably in an amount of from 88% to 94% by weight based on the total weight of the adhesive compound, and the ionic liquid 1-ethyl-3-methylimidazolium bis(fluorosulfonyl)imide (EMIM-FSI) as electrolyte, preferably in an amount of 3% to 10% by weight based on the total weight of the adhesive compound.

In addition to the base compound and the electrolyte, the adhesive compound preferably also contains at least one crosslinker, for which all the above embodiments and levels of preference likewise apply.

The adhesive compound of the disclosure is preferably a pressure-sensitive adhesive compound.

A pressure-sensitive adhesive compound is in the present case understood as meaning, as is generally usual, a substance that—particularly at room temperature—is durably tacky and adhesive. Characteristic of a pressure-sensitive adhesive compound is that it can be applied by pressure to a substrate and remains stuck there, the pressure to be applied and the duration of exposure to this pressure not being defined in more detail. In some cases, depending on the exact nature of the pressure-sensitive adhesive compound, the temperature, and the humidity, and on the substrate, the effect of a short-lived, minimal pressure that does not go beyond light contact for a brief moment is sufficient to achieve the adhesion effect; in other cases a more lengthy exposure to a high pressure may also be necessary.

Pressure-sensitive adhesive compounds have particular, characteristic viscoelastic properties that result in durable stickiness and adhesive capability. It is a characteristic feature thereof that, when they are mechanically deformed, the result is both viscous flow processes and the development of elastic resilience forces. The two processes are in a certain relation with one another that depends not just on the exact composition, the structure, and the degree of crosslinking of the pressure-sensitive adhesive compound, but also on the rapidity and duration of the deformation and on the temperature.

The viscous flow component is necessary for achievement of adhesion. Only the viscous components, brought about by macromolecules having relatively high mobility, allow good wetting and good flow onto the substrate to be bonded. A high proportion of viscous flow leads to high pressure-sensitive adhesiveness (also referred to as tack or surface stickiness) and hence often also to a high strength of adhesion. Highly crosslinked systems, or polymers that are crystalline or solidify in vitreous form, generally have at least only low pressure-sensitive adhesion, if any, for lack of free-flowing components.

The elastic resilience force components are needed for achievement of cohesion. They are brought about, for example, by very long-chain and entangled macromolecules that are crosslinked physically or chemically, and enable transmission of the forces that attack an adhesive bond. They have the effect that an adhesive bond can withstand a sustained stress acting thereon, for example in the form of a sustained shear stress, to a sufficient degree over a prolonged period of time.

For a more precise description and quantification of the measure of elastic and viscous components as well as the relation of the components to one another, the variables of storage modulus (G′) and loss modulus (G″), which can be determined by means of dynamic mechanical analysis (DMA, according to DIN EN ISO 6721), can be employed. G′ is a measure of the elastic component and G″ a measure of the viscous component of a substance. Both parameters are dependent on deformation frequency and temperature.

The parameters can be determined with the aid of a rheometer. The material under examination is subjected here to a sinusoidally oscillating shear stress, for example in a plate-plate arrangement. In the case of shear stress-controlled devices, deformation as a function of time and the time delay of this deformation are measured with respect to the onset of shear stress. This time delay is referred to as the phase angle δ.

The storage modulus G′ is defined as follows: G′=(τ/γ)·cos(δ) (τ=shear stress, γ=deformation, δ=phase angle=phase shift between shear stress vector and deformation vector).

The definition of the loss modulus G″ is: G″=(τ/γ)·sin(δ) (τ=shear stress, γ=deformation, δ=phase angle=phase shift between shear stress vector and deformation vector).

A substance is generally considered to be pressure-sensitive adhesive and is defined as pressure-sensitive adhesive for the purposes of the disclosure if at room temperature, here by definition at 23° C., in the deformation frequency range from 10⁰ to 10¹ rad/see, G′ is at least partly in the range from 10³ to 10⁷ Pa and if G″ is also at least partly in this range. “Partly” means that at least one portion of the G′ curve is within the window spanned by the deformation frequency range from inclusively 10⁰ to inclusively 10¹ rad/see (abscissa) and the range of the G′ values from inclusively 10³ to inclusively 10⁷ Pa (ordinate). For G″, this applies mutatis mutandis.

Preferably, the pressure-sensitive adhesive compound in the deformation frequency range from 10⁰ to 10¹ rad/see at 23° C. has a storage modulus G′ and a loss modulus G″ in the range from 10³ to 10⁷ Pa, determined according to DIN EN ISO 6721.

To achieve the viscoelastic properties, the monomers on which the polymers underlying the pressure-sensitive adhesive compound are based and any further components present in the pressure-sensitive adhesive compound, are in particular chosen such that the pressure-sensitive adhesive compound has a glass transition temperature (according to DIN 53765) below the use temperature (i.e. typically below room temperature (23° C.)). By means of suitable cohesion-enhancing measures, for example crosslinking reactions (formation of bridging linkages between the macromolecules), it is possible to enlarge and/or to shift the temperature range in which a polymer composition has pressure-sensitive adhesive properties. The range of application of the pressure-sensitive adhesive compounds can thus be optimized via a setting between flowability and cohesion of the composition.

In particular, the pressure-sensitive adhesive compound has a glass transition temperature of s 23° C., determined in accordance with DIN 53765.

In contrast to pressure-sensitive adhesive compounds, hot-melt adhesives, for example ones based on polyamides, polyurethanes or modified polyethylenes, typically display no stickiness at room temperature (23° C.), even though present in hot-melt adhesive compositions.

The present disclosure also provides an adhesive tape comprising at least one adhesive compound layer D of at least one adhesive compound of the disclosure.

The adhesive tape of the disclosure is preferably a double-sided adhesive tape. For the sake of simplicity, the adhesive tape of the disclosure is in the context of the present disclosure referred to as “adhesive tape” in the double-sided embodiments too.

The present disclosure relates to an adhesive tape, which may be present in any desired finished form but with preference given to rolls of adhesive tape. The adhesive tape, particularly in elongate sheet form, can be produced either in the form of a roll, i.e. rolled up on itself in the form of an Archimedean spiral, or as adhesive strips, as obtained for example in the form of blanks or die cuts.

The adhesive tape of the disclosure is in particular present in elongate sheet form. An elongate sheet is understood as meaning an object, the length of which (extent in the x direction) is many times greater than its width (extent in the y direction), the width remaining approximately and preferably exactly the same over the entire length.

The general expression “adhesive tape”, or else synonymously “adhesive strips”, encompasses for the purposes of the present disclosure all sheetlike structures such as films or film sections extending in two dimensions, tapes having extended length and limited width, sections of tape and the like, and lastly also die cuts or labels.

In addition to the longitudinal extent (x direction) and lateral extent (y direction), the adhesive tape also has a thickness (z direction) running perpendicular to the two extents, the lateral extent and longitudinal extent being many times greater than the thickness. The thickness is very substantially the same, preferably exactly the same within tolerances, over the entire areal extent of the adhesive tapes determined by their length and width.

The statements apply by analogy to the carrier layer(s) that form(s) a layer in the x and y direction as an element of the adhesive tape according to some preferred embodiments.

It is understood that the individual layers are arranged on top of one another along the z direction.

The present disclosure also provides a bonded composite comprising at least the following layers:
a first substrate A; and
a second substrate B; and
an adhesive tape of the disclosure that is arranged between the substrate A and the substrate B and bonds the substrates A and B together.

In particular, either the substrate A and the substrate B, or at least one of the substrates and the adhesive tape, or none of the substrates and the adhesive tape, are designed to be electrically conductive at two different points.

The present disclosure also provides a method for electrically debonding the composite of the disclosure, comprising at least the following method step:
i.) applying a voltage at two different points in the composite, the voltage preferably being from 2 to 50 V.

The voltage is applied according to step i.) of the method of the disclosure for electrically debonding the composite.

The voltage is in particular a DC voltage.

According to preferred embodiments of the disclosure, the voltage is from 3 to 12 V. Such a voltage can in particular be applied by means of a battery located in the immediate vicinity of the bond, such as, in particular and for example, in a mobile phone, tablet, etc.

According to further preferred embodiments of the disclosure, the voltage is from 12 to 50 V. This relatively high voltage allows redetachment to take place particularly swiftly; the voltage for this need only be applied for a few seconds.

Depending on the chosen voltage in particular, the duration of application of the voltage in step i.) can be from a few seconds, more particularly 2 seconds, up to 900 seconds, preferably up to 600 seconds.

It is of course also conceivable for the voltage to be applied for a period of time longer than 900 seconds, particularly if the voltage is relatively low.

The method of the disclosure for electrically debonding the composite of the disclosure allows the substrates A and B to be debonded from one another in a swift and easy manner without too much force being required.

If the layers do not separate from one another without further action after applying the voltage, the method of the disclosure comprises at least the following further method step:
ii.) applying force to the adhesive compound layer D and/or to substrate A and/or to substrate B, such that the distance between substrates A and B is increased.

The force that may still be required according to step ii) is significantly lower than the strength of adhesion prior to applying the voltage according to step i.)

The application of the voltage according to step i.) takes place at two different points on the bonded composite of the disclosure. The points at which the voltage is advantageously applied depend on the construction of the adhesive tape and of the bonded composite and thus on the nature of the individual layers and substrates A and B bonded together.

Some preferred embodiments are set out hereinbelow.

According to preferred embodiments, the adhesive tape is an adhesive transfer tape and consists of the adhesive compound layer D.

In a bonded composite comprising two substrates A and B, such an adhesive tape can advantageously be electrically debonded again by virtue of the fact that both substrates A and B are electrically conductive. For this, a voltage is applied to substrates A and B so that there is a migration of anions to the anode and of cations to the cathode in the adhesive compound. Without wishing to be bound to a particular theory, the inventors assume the following mechanism: Applying voltage results in a migration of the electrolyte in the adhesive compound layer D, more particularly a separation of the anions and cations of an ionic liquid. This results in the adhesion of the adhesive compound layer D to the substrate A and to the substrate B being greatly reduced and in the debonding of these layers from one another.

According to preferred embodiments of the present disclosure, the bonded composite thus comprises the following layers:
a first substrate A that is electrically conductive;
a second substrate B that is electrically conductive; and
an adhesive tape of the disclosure that consists of the adhesive compound layer D and is arranged between the substrate A and the substrate B and bonds the substrates A and B together.

According to further preferred embodiments, the adhesive tape comprises in addition to the first adhesive compound layer D at least the following layers:
a second adhesive compound layer C; and
at least one electrically conductive carrier layer T that is arranged between layers D and C.

An adhesive tape of this kind can as a double-sided adhesive tape be adapted to a variety of different substrates via the second adhesive compound layer C. These can in principle be the same substrates as those in the above embodiments in which the adhesive tape is an adhesive transfer tape.

However, an adhesive tape of this kind can in particular and advantageously also be used in order to later debond substrates A and B from one another when only one is electrically conductive, for example substrate A.

According to preferred embodiments, either xi.) only the carrier layer T or xii.) the carrier layer T and the second adhesive compound layer C are designed to be electrically conductive.

This means that a voltage can be applied to xi.) the electrically conductive carrier layer or xii.) to the second adhesive compound layer C and to the conductive substrate A.

The adhesive tape is initially advantageously bonded as a double-sided adhesive tape such that the electrically debondable adhesive compound layer D is attached to the conductive substrate A and the second adhesive compound layer to the substrate B, which can be conductive, but does not need to be.

Without wishing to be bound to a particular theory, the inventors assume the following mechanism: Applying the voltage results in a migration of the electrolyte in the adhesive compound layer D, more particularly a separation of the anions and cations of an ionic liquid. This results in the adhesion of the adhesive compound layer D to the substrate A being greatly reduced and in the debonding of these layers from one another.

According to preferred embodiments of the disclosure, xi.) only the carrier layer is electrically conductive. A voltage can in particular and preferably be applied particularly readily thereto when the carrier layer protrudes laterally over at least one of the adhesive compound layers.

According to further preferred embodiments of the disclosure, xii.) the carrier layer and the second adhesive compound layer C are electrically conductive. A construction of this kind has the advantage that the voltage can be applied to the adhesive compound layer C. A lateral overhang of the carrier layer is not necessary. The adhesive tape can therefore be produced in a simple manner, particularly since layers D, T and C can be die-cut together.

Preferably, the adhesive tape according to the embodiments described above consists of the three layers D, T, and C. This is also referred to in the context of the present disclosure as a three-layer composite D-T-C.

According to preferred embodiments of the present disclosure, the bonded composite thus comprises the following layers:
a first substrate A that is electrically conductive;
a second substrate B; and
an adhesive tape of the disclosure that consists of the three-layer composite D-T-C and bonds the substrates A and B together such that the adhesive compound layer D is attached to the conductive substrate A.

According to further preferred embodiments, the adhesive tape comprises in addition to the first adhesive compound layer D at least the following layers:
a second adhesive compound layer C;
at least one first electrically conductive carrier layer T that is arranged between layers D and C;
at least one second electrically conductive carrier layer T′ that is arranged on the surface of the adhesive compound layer D on the opposite side to the first electrically conductive carrier layer T; and
a third adhesive compound layer C′ that is arranged on the surface of the second electrically conductive carrier layer T′ on the opposite side to the first adhesive compound layer D.

An adhesive tape of this kind has at least the layer construction C-T-D-T′-C′ and, as a double-sided adhesive tape, can be adapted to a variety of different substrates via the adhesive compound layers C and C′.

These can in principle be the same substrates as those in the above embodiments in which the adhesive tape is an adhesive transfer tape or has the three-layer construction D-T-C.

However, an adhesive tape of this kind can in particular and advantageously be used in order to later debond substrates A and B from one another when neither is electrically conductive.

According to preferred embodiments, either xi.) only the carrier layers T and T′ or xii.) the carrier layers T and T′ and the second adhesive compound layer C and/or the third adhesive compound layer C′ are designed to be electrically conductive.

This means that voltage can be applied to xi.) both electrically conductive carrier layers or xii.) to at least one of the adhesive compound layers C and C′ and to one of the carrier layers or to the other adhesive compound layer.

By analogy with the above embodiments, it is assumed that applying the voltage results in a migration of the electrolyte in the adhesive compound layer D, more particularly a separation of the anions and cations of an ionic liquid. This results in the adhesion of the adhesive compound layer D to the electrically conductive carrier layers T and T′ being greatly reduced and in the debonding of these layers from one another.

According to preferred embodiments of the disclosure, xi.) only the carrier layers T and T′ are electrically conductive. A voltage can in particular and preferably be applied particularly readily thereto when the carrier layers T and T′ protrude laterally over at least one of the respectively adjacent adhesive compound layers.

According to further preferred embodiments of the disclosure, xii.) the carrier layers T and T′ and the second and third adhesive compound layer C and C′ are electrically conductive. A construction of this kind has the advantage that the voltage can be applied to the adhesive compound layers C and C′. A lateral overhang of the carrier layers T and T′ is not necessary. The adhesive tape can therefore be produced in a simple manner, particularly since layers C, T, D, T′, and C can be die-cut together.

Preferably, the adhesive tape according to the embodiments described above consists of the five layers C, T, D, T′, and C′. This is also referred to in the context of the present disclosure as a five-layer composite C-T-D-T′-C′.

According to preferred embodiments of the present disclosure, the bonded composite thus comprises the following layers:
a first substrate A;
a second substrate B; and
an adhesive tape of the disclosure that consists of the five-layer composite C-T-D-T′-C′ and bonds the substrates A and B together.

The electrically conductive substrate in all embodiments may be for example a metal casing of a mobile phone.

In all embodiments, the electrically non-conductive substrate may in particular be a casing made of a non-conductive material, such as plastic, or a battery or other non-electrically conductive components, for example speakers.

The present disclosure also provides for the use of the adhesive compound of the disclosure for the bonding of components in electronic devices, automobiles, medical devices, and dental devices.

The present disclosure also provides for the use of the adhesive tape of the disclosure for the bonding of components in electronic devices, automobiles, medical devices, and dental devices.

The carrier layers T or T and T′ in all the abovementioned embodiments are electrically conductive.

These layers are described hereinbelow. For the sake of simplicity, the term “electrically conductive carrier layer” or else just “carrier layer” is used. Depending on which one of the above embodiments, this refers to the carrier layer T or the carrier layers T and T′.

The carrier layers T and T′ are independent of one another and can be identical or different from one another.

Preferably, the electrically conductive carrier layer comprises at least one metal.

According to preferred embodiments of the disclosure, the metal is selected from the group consisting of copper, nickel, zinc, tin, silver, gold, aluminum, iron, chromium, and alloys of said metals. Very particularly preferably, the metal is selected from the group consisting of aluminum, zinc, copper, and nickel. Most preferred is aluminum.

Preferably, the electrically conductive carrier layer has a layer thickness, measured in the z direction, i.e. parallel to the stacking direction of the layer arrangement, of from 10 nm (nanometers) to 50 μm (micrometers).

According to preferred embodiments of the disclosure, the electrically conductive carrier layer includes a) at least one metal foil, preferably an aluminum foil, and/or b) at least one electrically conductive textile including at least one metal, preferably selected from the group consisting of copper and nickel, and/or c) one or more plies of at least one metal deposited by vapor deposition, preferably selected from the group consisting of copper and aluminum, and/or d) at least one metal grid and/or e) a foil coated with metal by vapor deposition.

In principle, it is also conceivable here for the layer T to include a combination of two or more of the above options.

Metal foils, for example and preferably aluminum foils, are known to those skilled in the art.

The metal foil, for example and preferably the aluminum foil, preferably has a layer thickness, measured in the z direction, i.e. parallel to the stacking direction of the layer arrangement, of from 5 to 50 μm, more preferably from 10 to 30 μm.

Electrically conductive textiles are known to those skilled in the art, in particular under the expression “conductive mesh”. This is a textile fabric, for example one made of PET (polyethylene terephthalate), that is coated with a metal, for example with copper and/or nickel, this being how the electrical conductivity of the fabric is produced.

Those skilled in the art are likewise aware that metals can undergo direct vapor deposition as a monolayer or multilayer onto surfaces such as in this case the surface of an adhesive compound layer.

In the context of the present disclosure, the electrically conductive carrier layer can be provided by vapor deposition of metal onto the adhesive compound layer D or the adhesive compound layer C or the adhesive compound layer C′.

In addition, those skilled in the art are familiar with metal grids of varying dimensions. Metal grids having suitable layer thicknesses can be produced for example through a laid scrim of appropriately fine metal threads or by die-cutting at least one foil of appropriate layer thickness.

In the case of a film coated with metal by vapor deposition, a non-conductive film in particular is coated with metal by vapor deposition in order to make it electrically conductive. The film material can in principle be selected from all materials capable of undergoing vapor deposition with metal and of being used as a carrier film in adhesive tapes. The material is selected in particular from polyesters and polyolefins, a mixture of more than one material also being conceivable. Particularly preferred polyesters are polyethylene terephthalate (PET) and polyethylene naphthalate (PEN). Particularly preferred polyolefins are polypropylene (PP) and polyethylene (PE). According to preferred embodiments, the film material is selected from the group consisting of PET, PEN, PE, and PP.

Preferably, it is a PET (polyethylene terephthalate) film. A film of this kind is dimensionally stable and therefore easy to process without significant stretching or tearing. This makes it possible to durably apply a homogeneous and gapless metal layer, with the result that the electrical conductivity, particularly in the z direction, is durably guaranteed across the entire film.

In the embodiments in which at least one electrically conductive carrier layer T or at least two electrically conductive carrier layers T and T′ are present, it is preferable that this at least one adjacent adhesive compound layer protrudes laterally in at least one direction of extension of the layer plane and thus includes a lateral overhang. A voltage can then be applied to this lateral overhang in a simple manner.

In the case of the five-layer composite, the lateral overhangs of the electrically conductive carrier layers T and T′ are in advantageous embodiments arranged spatially apart from one another. This makes it easier to apply a voltage to said two overhangs.

In the case of metal deposited by vapor deposition as a carrier layer, it is preferable that this carrier layer protrudes laterally in at least one direction of extension of the layer plane over just one adjacent adhesive compound layer, the respective other adhesive compound layer serving as a mechanical support for this metal layer. The metal layer in this case has no actual carrier function. Rather, the other adhesive compound layer serves as a carrier for the metal layer. For the sake of simplicity, the term carrier layer is however retained for the metal layer in these embodiments too. Preferably, the layer thickness of layer T is in this case greater than or equal to 10 nm (nanometers), preferably 50 to 200 nm.

According to preferred embodiments of the disclosure, the electrically conductive carrier layer T or T and/or T′ includes a) at least one metal foil, preferably an aluminum foil, and/or b) at least one electrically conductive textile including at least one metal, preferably selected from the group consisting of copper and nickel, and/or d) at least one metal grid and/or e) a film coated with metal by vapor deposition, and protrudes over the first adhesive compound layer D and the second adhesive compound layer C or the first adhesive compound layer D and the second adhesive compound layer C and/or the first adhesive compound layer D and the third adhesive compound layer C′ in at least one direction of extension.

This allows a voltage to be applied to the carrier layer in a simple and safe manner. At the same time, the adhesive tape can be produced in a relatively simple manner.

According to preferred embodiments of the disclosure, the electrically conductive carrier layers T or T and/or T′ include one or more plies, preferably one ply, of at least one vapor-deposited metal, preferably selected from the group consisting of copper and aluminum.

According to particularly preferred embodiments of the disclosure, the electrically conductive carrier layer T or T and/or T′ includes e) a film coated with metal by vapor deposition, and protrudes over the first adhesive compound layer D in at least one direction of extension. In this case, the film is coated with metal by vapor deposition, in particular on one surface, and the respective carrier layer is attached via the metalized surface to the first adhesive compound layer D, and thus to the electrically detachable layer.

This allows a voltage to be applied to the carrier layer in a simple and safe manner.

The expression “protrude laterally” is understood in the context of the present disclosure as meaning any kind of lateral overhang of the layer(s) concerned and means that the layer respectively concerned extends beyond the layer of reference, more particularly in the “xy” plane and thus laterally, i.e. perpendicular to the stacking direction. In the context of the present disclosure, the terms “lateral extension” or “section of lateral extension” are also used instead of the term “lateral overhang”.

The term “lateral” refers here to each direction of extension of the layer plane “xy” perpendicular to the stacking direction of the layers “z”. The term is thus in particular independent of the geometric shape of the adhesive tape in the “xy” plane, which can for example be a rectangle, as is customary for adhesive tapes (see above), but can also be a square or a circle.

The term does not encompass minor fluctuations in the dimensions of the individual layers in the “xy” plane that result from the die-cutting process or similar shaping processes, particularly since the dimensions of such minor material overhangs preclude the application of a voltage thereto in the planned manner.

The adhesive compound layers C or C and C′ can in principle be based on the same compounds as the adhesive compound layer D; the adhesive compounds of layers C or C and C′ do not have to contain any electrolytes, but may do. Preferably, the layers C or C and C′ do not contain any electrolytes.

According to some embodiments of the three-layer composite D-T-C described above, the adhesive compound layer C is electrically conductive.

Likewise, the adhesive compound layer C and/or adhesive compound layer C′ of the five-layer compound C-T-D-T′-C′ can be designed to be electrically conductive.

These layers are described hereinbelow. For the sake of simplicity, the term “electrically conductive adhesive compound layer” is used where appropriate. Depending on which one of the above embodiments, this refers to the adhesive compound layer C or adhesive compound layers C and/or C′. In addition, for the sake of simplicity, the expression “the adhesive compound layers C or C and/or C′” is used, this meaning the respective layers in the described embodiments of the adhesive tape that include at least the three-layer composite or at least the five-layer composite.

The adhesive compound layers C and C′ are independent of one another and may be identical or different from one another.

Preferably, the electrically conductive adhesive compound layer comprises at least one metal for this purpose, such as in particular nickel, copper or silver, preferably in the form of electrically conductive metal particles and/or metalized particles, more preferably metal particles.

Metalized particles are in particular and preferably glass or polymer particles metalized with at least one metal, with the result that the previously electrically non-conductive particles are made electrically conductive by the metalization.

Particularly preferably, the electrically conductive adhesive compound layer comprises electrically conductive particles selected from the group consisting of nickel particles, copper particles, and silver-coated copper particles.

According to particularly preferred embodiments, the electrically conductive adhesive compound layer comprises nickel particles.

Preferably, the electrically conductive adhesive compound layer contains 5% to 40% by weight, particularly preferably 20% to 40% by weight, very particularly preferably 25% to 35% by weight, of electrically conductive particles, in particular metal particles and/or metalized particles, based on 100% by weight of the polymers and tackifier resins present.

The electrically conductive particles should preferably be not larger, or not significantly larger, than the respective thickness of the electrically conductive adhesive compound layer in the z direction, measured with a light microscope.

Preferably, the electrically conductive particles have an average particle size of from 1 to 10 μm, more preferably from 1 to 6 μm, even more preferably from 3 to 5 μm, such as in particular 4 μm.

The electrically conductive adhesive compound layer is in particular electrically conductive at least in the z direction.

However, it may also be electrically conductive in the xy plane. If the electrically conductive adhesive compound layer is designed to be electrically conductive only in the z direction, but not necessarily in the xy direction, a smaller amount of these materials is needed in preferred embodiments in which a metal, in particular metal particles, is added to achieve the electrical conductivity. This optimizes the adhesive compound with regard to the required conductivity, strength of adhesion, flow behavior, and also costs.

A layer is considered to be “electrically conductive” in the context of the present disclosure in particular when the resistance is less than 1 ohm, as measured in the respective direction, in this case more particularly in the z direction, according to the standard MIL-DTL-83528C.

Irrespective of whether the adhesive compound layers C or C and/or C′ are designed to be electrically conductive, the statements below apply.

The adhesive compound in the adhesive compound layers C or C and/or C′ is according to preferred embodiments not a pressure-sensitive adhesive compound.

According to particularly preferred embodiments of the disclosure, the adhesive compound in the adhesive compound layers C or C and C′ is a pressure-sensitive adhesive compound and the adhesive compound layer C or C and C′ is thus a layer of pressure-sensitive adhesive.

The adhesive compound layers C or C and/or C′ are according to preferred embodiments of the disclosure—like the adhesive compound layer D—adhesive compounds comprising the phases (i) and (ii).

According to preferred embodiments of the disclosure, in the adhesive compound layers C or C and/or C′ the poly(meth)acrylate and—if present—tackifier resin used in phase (i) and the vinylaromatic block copolymer used in phase (ii) are the same as those used in the adhesive compound layer D.

This makes it possible in particular to bond together similar substrates, here referred to as A and B.

According to further preferred embodiments of the disclosure, the adhesive compound used in the adhesive compound layers C or C and/or C′ is a different adhesive compound to the one used in the adhesive compound layer D.

This makes it possible to adapt the properties of the conductive layer particularly well to the substrate(s) bonded via the adhesive compound layer C or C and/or C′. Since the adhesive compound layer C or C and/or C′ preferably does not contain any electrolytes, such as an ionic liquid, or does not have to contain one, the constituents do not have to be adapted thereto.

According to preferred embodiments of the disclosure, the adhesive compound used in the adhesive compound layers C or C and/or C′ is a different adhesive compound to the one used in the adhesive compound layer D; the adhesive compound in the adhesive compound layers C or C and/or C′ may be a heat-activatable adhesive compound or an acrylate-based pressure-sensitive adhesive compound.

The adhesive compound in the adhesive compound layer D and—depending on the embodiment—further adhesive compounds are produced by known processes and brought into layer form, in particular by coating. This can be done by using one or more suitable solvents or else without use of solvents.

In addition, one or more drying steps may optionally be performed. The adhesive compounds of the disclosure are however preferably produced by extrusion without use of solvents, which is a further advantage of the present disclosure. This means that, even during production of the adhesive compounds and adhesive compound layers of the disclosure, it is possible—in addition to the later possibility of redetachment—to further boost the degree of sustainability by avoiding the use of solvents.

The lamination of a plurality of layers on top of one another is effected in a manner known to those skilled in the art, the layers being superposed such that this affords in particular a layer composite DTC, where T is arranged between D and C, or C′-T′-D-T-C as a double-sided adhesive tape.

The carrier layers T and T′ can be provided in various ways as already described above.

Thus, it is conceivable that a) a metal foil, in particular an aluminum foil, and/or b) an electrically conductive mesh and/or d) at least one metal grid and/or e) a PET film coated with metal by vapor deposition is positioned between the respective adhesive compound layers.

In addition, it is possible for c) metal particles to undergo direct vapor deposition onto the surface of the adhesive compound layer D or C or C′.

The adhesive tape of the disclosure is in particular a double-sided adhesive tape in which, depending on the embodiment, two surfaces of the adhesive compound layer D (adhesive transfer tape) or a surface of the first adhesive compound layer D and a surface of the second adhesive compound layer C (three-layer composite D-T-C) or one surface each of the adhesive compound layers C and C′ (five-layer composite C-T-D-T′-C′) are available for bonding to substrates.

Advantageously, the outer, exposed surfaces of the adhesive compound layers of the adhesive tape of the disclosure can be provided with anti-adhesive materials, such as a release paper or a release film, also termed a liner. A liner may also be a material having anti-adhesive coating on at least one side, preferably on both sides, for example double-sidedly siliconized material. A liner, or in more general terms a temporary carrier, is not part of an adhesive tape, but merely an auxiliary for the production and/or storage thereof and/or for further processing by die-cutting. Furthermore, a liner, as opposed to a permanent carrier, is not firmly bonded to an adhesive layer but instead functions as a temporary carrier, i.e. as a carrier that can be peeled away from the adhesive layer. “Permanent carriers” are also referred to synonymously simply as “carriers” in the present application.

The thickness of the individual adhesive compound layer(s) (in the z direction) is preferably from 15 to 2000 μm, particularly preferably from 20 to 500 μm, very particularly preferably from 25 to 200 μm. However, the thickness is preferably as small as possible, for example 100 μm or less.

In the embodiments of the three-layer composite D-T-C and the five-layer composite C-T-D-T′-C′, the adhesive compound layers D and C, and D and C and C′, have different layer thicknesses in preferred embodiments, the thickness of the adhesive compound layer D being for example less than that of the adhesive compound layers C and C′.

In further preferred embodiments, the layers D and C or D, C, and C′ have the same layer thickness.

If the layer thickness of layer D is too high, this may become uneconomically costly on account of the electrolytes present therein.

To boost the anchoring of the adhesive compound layer(s) on a carrier layer, if desired, the carrier layer can be chemically and/or physically pretreated, in particular physically pretreated. Corona, plasma or flame pretreatment is conceivable. Corona surface treatment is also known for metalized films to those skilled in the art and is described for example in EP 0355622 A2.

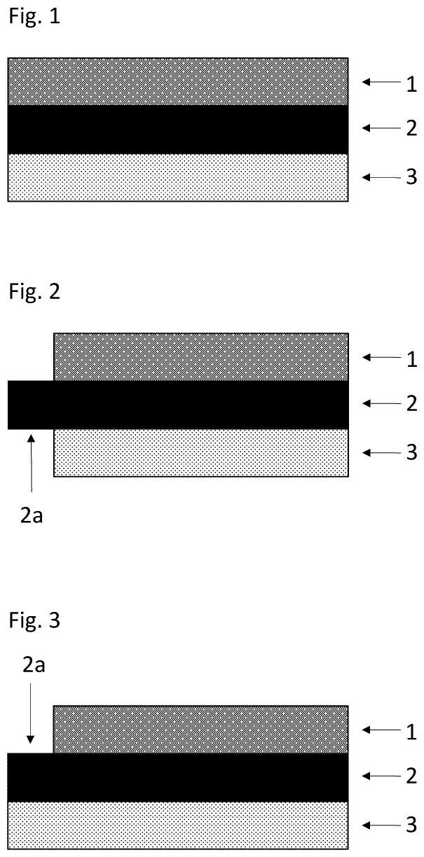

As can be seen in FIG. 1, the adhesive compound layer D 1 is attached via one of its surfaces to the carrier layer T 2. The second adhesive compound layer C 3 is arranged on the surface of the carrier layer T on the opposite side to the layer D.

As can also be seen in FIG. 1, the layer composite represents a double-sided adhesive tape in which a surface of the adhesive compound layer D and a surface of the second adhesive compound layer C are each available for bonding.

FIG. 2 shows a preferred embodiment of the disclosure. In this case, the electrically conductive carrier layer T 2 protrudes laterally over the adhesive compound layer D 1 and over the second adhesive compound layer C 3 in at least one direction of extension of the layer plane, such that the electrically conductive carrier layer T 2 includes an overhang having at least one free surface 2a.

FIG. 3 shows a further preferred embodiment of the disclosure. In this case, the electrically conductive carrier layer T 2 protrudes laterally over the adhesive compound layer D 1 in at least one direction of extension of the layer plane, such that the electrically conductive carrier layer T 2 includes an overhang having a free surface 2 a. In FIG. 3, the adhesive compound layer C 3 is formed such that it likewise includes an overhang relative to the layer D 1. The carrier layer T 2 is in particular a PET film coated with aluminum on one side, the aluminized side being attached to the layer D 1.

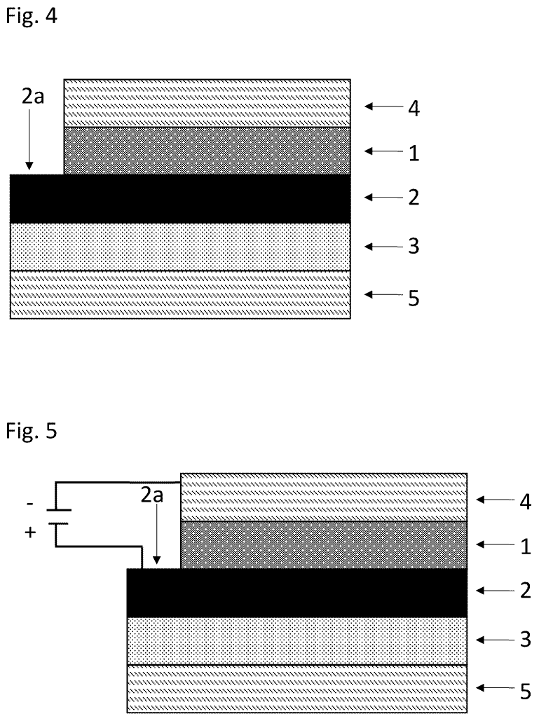

FIG. 4 shows a schematic representation of the bonded composite of the disclosure in a preferred embodiment. As can be seen from FIG. 4, the adhesive tape is arranged over the adhesive compound layer D 1 on a surface of the first substrate A 4, the first substrate being electrically conductive.

In addition, the adhesive tape is arranged over the second adhesive compound layer C 3 on a surface of a second substrate B 5.

FIG. 4 likewise shows by way of example the lateral protrusion of the electrically conductive carrier layer T 2 over the adhesive compound layer D 1 in at least one direction of extension of the layer plane, such that the electrically conductive carrier layer T includes an overhang having a free surface 2a.

It is now possible to apply a voltage via this free surface 2a, as shown in the schematic representation in FIG. 5.

Applying the voltage results in a migration of the electrolyte in the adhesive compound layer D 1, more particularly a separation of the anions and cations of an ionic liquid.

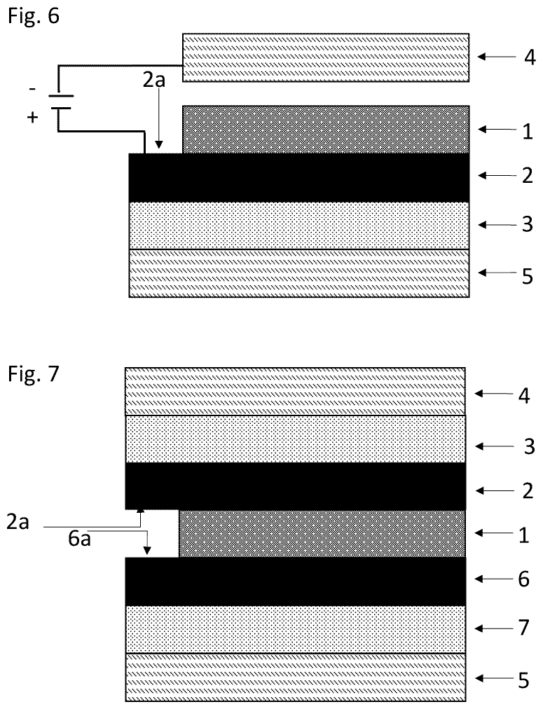

This results in the adhesion of the adhesive compound layer D 1 to the substrate A 4 being greatly reduced and in the debonding of these layers from one another, as can be seen in the schematic representation in FIG. 6.

In FIG. 7, a further schematic representation of the bonded composite of the disclosure is shown in a preferred embodiment. As can be seen from FIG. 7, the adhesive tape is arranged over the adhesive compound layer C 3 on a surface of the first substrate A 4.

In addition, the adhesive tape is arranged over the third adhesive compound layer C′ 7 on a surface of a second substrate B 5.

Present between the layers C 3 and C′ 7 are the electrically detachable adhesive compound layer D 1 and two electrically conductive carrier layers T 2 and T′ 6, the layer D 1 being arranged between the carrier layers.

FIG. 7 likewise shows by way of example the lateral protrusion of the electrically conductive carrier layer T 2 and of the electrically conductive carrier layer T′ 6 over the adhesive compound layer D 1 in each case in at least one direction of extension of the layer plane, such that the electrically conductive carrier layer T includes an overhang having a free surface 2a and the electrically conductive carrier layer T′ includes an overhang having a free surface 6a.

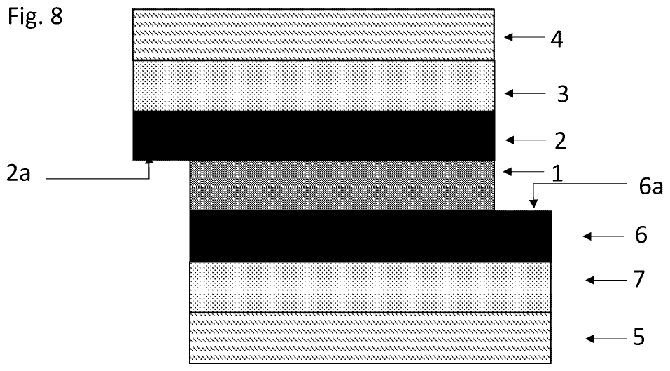

In FIG. 8, a further schematic representation of the bonded composite of the disclosure is shown in a preferred embodiment similar to the representation in FIG. 7. In contrast to FIG. 7, the overhangs of the electrically conductive carrier layer T 2 and the electrically conductive carrier layer T′ 6 are however in different directions, with the result that the resulting free surfaces of these layers 2a and 6a are spatially separated.

It is now possible to apply a voltage via these free surfaces 2a and 6a in analogous manner to FIG. 5. In contrast to the embodiment shown in FIG. 5, the voltage can be applied to surfaces 2a and 6a, which means there is no need for either of substrates A and B to be electrically conductive.

Applying the voltage results in a migration of the electrolyte in the adhesive compound layer D 1, more particularly a separation of the anions and cations of an ionic liquid. This results in the adhesion of the adhesive compound layer D 1 to the carrier layers T 2 and/or T′ 6 being greatly reduced and in the debonding of these layers from one another. More particularly, detachment occurs at the layer to which the negative pole is applied.

The application of the voltage is simplified in the case of the spatially separated surfaces 2a and 6a as per FIG. 8.

The representations in FIGS. 1 to 8 are schematic representations as shown. In particular, the layer thicknesses of the individual layers D, T, and C may differ from one another. Moreover, the substrates A and B are represented as further layers only schematically. These can of course have any other spatial geometry.

A number of examples are described hereinbelow for further illustration of the disclosure. The examples marked with “I” are examples of adhesive compounds of the disclosure, whereas the examples marked with “C” are comparative examples.

Tables 1 and 3 show the constituents of the adhesive compounds for which the electrical detachability is being investigated. The numerical values are parts by weight, where the sum total of the parts by weight of the base compound comes to 100 and the amounts of crosslinker and electrolyte are added on top of this.

### Substances Used

P1: Polymethacrylate, produced as described below;
P2: Polymethacrylate, produced as described below;
SOL T 190: Europrene® SOL T 190, SIS: Styrene-isoprene-styrene block copolymer from Versalis;
Kraton® D1118: Styrene-butadiene block copolymer from Kraton Polymers;
Calprene® 718: Styrene-butadiene-styrene block copolymer from Dynasol Elastomers;
Tackifier resin: Paraloid™ DM-55 from Dow;
Filler: Unexpanded microballoons, Expancel® 920DU40 from Nouryon;
PPG: Polypropylene glycol;
Uvacure® 1500: Crosslinker: 3,4-Epoxycyclohexylmethyl 3,4-epoxycyclohexanecarboxylate from Syensqo;
Al chelate: Crosslinker: Catana™ CAA 2072 from Sachen
EMIM-FSI: Electrolyte: ionic liquid 1-ethyl-3-methylimidazolium bis(fluorosulfonyl)imide;
EMIM-TFSI: Electrolyte: ionic liquid 1-ethyl-3-methylimidazolium bis(trifluorosulfonyl)imide; and
BMIM-PF₆: Ionic liquid 1-butyl-3-methylimidazolium hexafluorophosphate

The polymethacrylate P1 was produced as follows:

A conventional 300 I reactor for free-radical polymerizations was charged with 57 kg of n-butyl acrylate, 20 kg of methyl acrylate, 20 kg of benzyl acrylate, 3 kg of acrylic acid, and 100 kg of acetone/isopropanol (96/4). After passing nitrogen gas through the reactor for 45 minutes with stirring, the reactor was heated to 58° C. and 38 g of Vazo® 67 (2,2′-azobis(2-methylbutyronitrile)) was added. The jacket temperature was then heated to 65° C. and the reaction was carried out constantly at this external temperature. A further 38 g of Vazo® 67 was added after a reaction time of 1 h and again after 2 h. After 3 h, the reaction mixture was diluted with 20 kg of acetone/isopropanol (96:4) and after 6 h with 10 kg of acetone/isopropanol (96:4). To reduce residual monomers, 0.15 kg of Perkadox®16 (di(4-tert-butylcyclohexyl) peroxydicarbonate) was added after 5.5 h and again after 7 h. The reaction was terminated after 24 h reaction time and the reaction mixture cooled to room temperature. The solution was adjusted to a solids content of 38% by weight.

The polymethacrylate P2 was produced as follows:

A conventional 300 I reactor for free-radical polymerizations was charged with 47 kg of n-butyl acrylate, 20 kg of methyl acrylate, 30 kg of benzyl acrylate, 3 kg of acrylic acid, and 100 kg of ethyl acetate/isopropanol (96/4). After passing nitrogen gas through the reactor for 45 minutes with stirring, the reactor was heated to 58° C. and 38 g of Vazo® 67 (2,2′-azobis(2-methylbutyronitrile)) was added. The jacket temperature was then heated to 65° C. and the reaction was carried out constantly at this external temperature. A further 38 g of Vazo® 67 was added after a reaction time of 1 h and again after 2 h. After 3 h, the reaction mixture was diluted with 20 kg of ethyl acetate/isopropanol (96/4) and after 6 h with 10 kg of ethyl acetate/isopropanol (96/4). To reduce residual monomers, 0.15 kg of Perkadox® 16 (di(4-tert-butylcyclohexyl) peroxydicarbonate) was added after 5.5 h and again after 7 h. The reaction was terminated after 24 h reaction time and the reaction mixture cooled to room temperature. The solution was adjusted to a solids content of 38% by weight.

The polymethacrylate P3 was produced as follows:

A conventional 4 I reactor for free-radical polymerizations was charged with 204 g of n-butyl acrylate, 72 g of N,N-dimethylacrylamide, 116 g of 2-ethylhexyl acrylate, 8 g of acrylic acid, and 400 g of ethyl acetate/isopropanol (96/4).

After passing nitrogen gas through the reactor for 45 minutes with stirring, the reactor was heated to 58° C. and 0.2 g of Vazo® 67 (2,2′-azobis(2-methylbutyronitrile)) was added and the metered addition of the solvent and monomer mixture commenced. The metered addition was over a period of two hours, the mixture having the following composition: 306 g of n-butyl acrylate, 108 g of N,N-dimethylacrylamide, 174 g of 2-ethylhexyl acrylate, 12 g of acrylic acid, and 600 g of ethyl acetate/isopropanol (96/4). The jacket temperature was then heated to 65° C. and the reaction was carried out constantly at this external temperature. After 45 min, the temperature is increased to 72° C. for 2 hours. Before it is reduced to 70° C. after 2 h for the remaining 6.25 h reaction time. In addition to the initiation at the start of the reaction, 0.3 g of Vazo® 67 is added after 30 min, 0.4 g after 45 min, and 0.4 g after 60 min. To reduce residual monomers, 0.15 g of Perkadox® 16 (di(4-tert-butylcyclohexyl) peroxydicarbonate) was added after 5.5 h and a further 0.1 g after 7 h. The reaction was terminated after 9 h reaction time and the reaction mixture cooled to room temperature. The solution was adjusted to a solids content of 38% by weight.

The adhesive compounds in Table 1 were produced as follows:

The synthetic rubber (Europrene® SOLT190) in pellet form was melted via a solids dosing unit in a planetary roll extruder.

The polyacrylate P1 concentrated and premelted in a single-screw extruder, the tackifier resin, and the microballoons were then metered in. The electrolyte/ionic liquid, if present in the composition, was added to the mixture.

In addition, the crosslinker was added. The melt was mixed thoroughly and formed into a layer with a thickness of 60 or 150 μm via a two-roll calender between two release films (siliconized PET film).

TABLE 1

| | Constituents | | | | | | |
|---|---|---|---|---|---|---|---|
| Base compound | C1 | C2 | C3 | I1 | I2 | I3 | I4 |
| P1 | 99 | 51.75 | 51.75 | 51.75 | 51.75 | 62.85 | 49 |
| SOL T 190 | — | 34 | 34 | 34 | 34 | 20 | 32.7 |
| Tackifier resin | — | 13.5 | 13.5 | 13.5 | 13.5 | 16.4 | 17.3 |
| Filler | 1 | 0.75 | 0.75 | 0.75 | 0.75 | 0.75 | 1 |
| Sum total/ | 100 | 100 | 100 | 100 | 100 | 100 | 100 |
| base compound | | | | | | | |
| Uvacure ®1500 | 0.85 | 0.47 | 0.47 | 0.47 | 0.47 | 0.54 | 0.44 |
| EMIM-FSI | 5 | 0 | 2 | 5 | 3.5 | 5 | 7.6 |

These adhesive compounds to be investigated in respect of electrical detachability were used to produce examples of the disclosure and comparative examples for adhesive tapes.

### Three-Layer Laminates

In the case of adhesive compounds C1 to 03 and 11 to 13, 60 μm thick first adhesive compound layers were in each case laminated with a 23 μm thick aluminum-coated PET carrier material, and a second adhesive compound layer with a thickness of 75 μm on the other side of the carrier material. The aluminum-coated side of the carrier was here contacted with the first adhesive compound layer to be investigated in respect of electrical detachability. The adhesive compound used in the second adhesive compound layer was a foamed acrylate-SIS adhesive compound (51% by weight of polyacrylate based on a monomer composition of 7% by weight of acrylic acid, 68% by weight of ethylhexyl acrylate, 25% by weight of methyl acrylate; 34% by weight of SIS (Europrene® SOLT190), 14% by weight of Paraloid™ DM-55; 1% by weight of Expancel® 920DU40; plus 0.1% by weight of Uvacure® 1500; foaming in-line during extrusion, coated in the foamed state onto the carrier material), which did not contain any electrolyte and was therefore not designed to be electrically detachable.

The layers were laminated on top of one another such that the aluminum-coated carrier material and the second adhesive compound layer present thereunder protruded laterally over the first adhesive compound layer, as also shown schematically in FIG. 3.

The resulting adhesive tapes are identified as K-“identifier of the adhesive compound”. Examples of the disclosure are those in which one of the adhesive compounds of the disclosure is used.

The adhesive tapes were tested in respect of their electrical detachability based on strength of adhesion on steel; the strength of adhesion was tested before applying a voltage and further test specimens had a voltage of 12 V applied for 60 seconds before determining the strength of adhesion.

The voltage was in this case applied at the lateral overhang of the Al-coated carrier material and at one of the steel substrates.

The adhesive tapes were also investigated in respect of static and dynamic shear strength.

Further details on the test methods are given in the “Test methods” section below.

The results are collated in Table 2.

TABLE 2

| Properties | K-C1 | K-C2 | K-C3 | K-I1 | K-I2 | K-I3 |
|---|---|---|---|---|---|---|
| Strength of adhesion/ | 10.9 | 12.8 | 11.7 | 10.8 | 11.6 | 11.1 |
| steel, RT [N/cm] | | | | | | |
| Strength of adhesion/ | 0.02 | 12.01 | 9.63 | 0.03 | 0.69 | 0.03 |
| steel, RT after 12 V, | | | | | | |
| 60 s [N/cm] | | | | | | |
| Strength of adhesion/ | 6.4 | 9.1 | 9.5 | 8.7 | 8.8 | 11.1 |
| steel, 60° C., 95% RH | | | | | | |
| [N/cm] | | | | | | |
| Strength of adhesion/ | 0.39 | 9.00 | 9.0 | 0.14 | 0.47 | 0.06 |
| steel, 60° C., 95% RH, | | | | | | |
| after 12 V, 60 s [N/cm] | | | | | | |
| Dyn. shear strength | 0.49 | 1.06 | 1.01 | 0.92 | 0.95 | 1.06 |
| [N/mm²] | | | | | | |
| Stat. shear strength | 22 | 10000 | 10000 | 10000 | 748 | 711 |
| [min] | | | | | | |

The adhesive compounds in Table 3 were produced as follows:

To the polymer P2 produced in solvent were added the respective vinylaromatic block copolymer, the ionic liquid 1-ethyl-3-methylimidazolium bis(trifluoromethylsulfonyl)imide (EMIM-TFSI), and the specified crosslinker. The amounts in each case refer to the substances without solvent.

TABLE 3

Constituents

| Base compound | C4 | C5 | C6 | I5 | I6 |
|---|---|---|---|---|---|
| P2 | 100 | 80 | 80 | 80 | 80 |
| Kraton ® D1118 | — | 20 | — | 20 | — |
| Calprene ® 718 | — | — | 20 | — | 20 |
| Sum total/ | 100 | 100 | 100 | 100 | 100 |
| base compound | | | | | |
| Al chelate | 0.2 | 0.2 | 0.2 | 0.2 | 0.2 |
| EMIM-TFSI | 4.8 | 0 | 0 | 4.8 | 4.8 |

The resulting mixture was then coated with a coating bar onto a PET liner furnished with a separating silicone, so that after drying at 110° C. a layer thickness of 60 μm had formed.

These adhesive compounds to be investigated in respect of electrical detachability were used to produce examples of the disclosure and comparative examples for adhesive tapes.

### Three-Layer Laminates

The adhesive compounds to be investigated in respect of electrical detachability were used in three-layer laminates, as in the case of examples K-C1 to K-I3.

In contrast to the abovementioned examples, a tin-coated PET film with a layer thickness of 23 μm was used as carrier layer.

The foamed acrylate-SIS adhesive compound described above was used as the second layer of adhesive.

The layers were here too laminated on top of one another such that the tin foil serving as carrier material and the second adhesive compound layer present thereunder protruded laterally over the first adhesive compound layer, as also shown schematically in FIG. 3.

The resulting adhesive tapes were likewise tested in respect of their electrical detachability and shear resistance.

The results are collated in Table 4.

TABLE 4

| Properties | K-C4 | K-C5 | K-C6 | K-I5 | K-I6 |
|---|---|---|---|---|---|
| Strength of | 6.89 | 9.06 | 8.57 | 8.24 | 7.12 |
| adhesion/steel, | | | | | |
| RT [N/cm] | | | | | |
| Strength of | 0.08 | 8.97 | 8.43 | 0.15 | 0.07 |
| adhesion/steel, | | | | | |
| RT after 12 V, | | | | | |
| 60 s [N/cm] | | | | | |
| Strength of | 7.98 | 9.67 | 9.04 | 9.93 | 8.79 |
| adhesion/steel, | | | | | |
| 60° C., 95% | | | | | |
| RH [N/cm] | | | | | |
| Strength of | 0.11 | 9.55 | 8.98 | 0.23 | 0.12 |
| adhesion/steel, | | | | | |
| 60° C., 95% | | | | | |
| RH, after 12 V, | | | | | |
| 60 s [N/cm] | | | | | |
| Dyn. shear | 0.85 | 1.1 | 1.02 | 1.1 | 1.01 |
| strength | | | | | |
| [N/mm²] | | | | | |
| Stat. shear | 2500 | 10000 | 10000 | 10000 | 10000 |
| strength [min] | | | | | |

The adhesive compounds in Table 5 were produced in analogous manner to the examples in Table 1 as follows:

The synthetic rubber (Europrene® SOLT190) in pellet form was melted via a solids dosing unit in a planetary roll extruder.

The polyacrylate P3 concentrated and premelted in a single-screw extruder, the tackifier resin, the PPG, and the microballoons were then metered in. The electrolyte/ionic liquid was added to the mixture.

TABLE 5

| | Constituents | | |
|---|---|---|---|
| Base compound | I7 | I8 | I9 |
| P3 | 52 | 47.5 | 47.5 |
| SOL T 190 | 34.7 | 31.6 | 31.6 |
| Tackifier resin | 12.3 | 16.8 | 16.8 |
| Filler | 1.0 | 1.0 | 1.0 |
| PPG | — | 3.1 | 3.1 |
| Sum total/ | 100 | 100 | 100 |
| base compound | | | |
| Uvacure ®1500 | 0.47 | 0.43 | 0.43 |
| BMIM PF₆ | 7 | 7 | 5 |

In addition, the crosslinker was added. The melt was mixed thoroughly and formed into a layer with a thickness of 60 or 150 μm via a two-roll calender between two release films (siliconized PET film).

These adhesive compounds to be investigated in respect of electrical detachability were used to produce examples of the disclosure and comparative examples for adhesive tapes.

### Three-Layer Laminates

In the case of adhesive compounds I7 to I9, 60 μm thick first adhesive compound layers were in each case laminated with a 23 μm thick tin-coated PET carrier material and a second adhesive compound layer with a thickness of 75 μm on the other side of the carrier material. The tin-coated side of the carrier was here contacted with the first adhesive compound layer to be investigated in respect of electrical detachability. The adhesive compound used in the second adhesive compound layer was a foamed acrylate-SIS adhesive compound (51% by weight of polyacrylate based on a monomer composition of 7% by weight of acrylic acid, 68% by weight of ethylhexyl acrylate, 25% by weight of methyl acrylate; 34% by weight of SIS (Europrene® SOLT190), 14% by weight of Paraloid™ DM-55; 1% by weight of Expancel® 920DU40; plus 0.1% by weight of Uvacure® 1500; foaming in-line during extrusion, coated in the foamed state onto the carrier material), which did not contain any electrolyte and was therefore not designed to be electrically detachable.

The layers were laminated on top of one another such that the tin-coated carrier material and the second adhesive compound layer present thereunder protruded laterally over the first adhesive compound layer, as also shown schematically in FIG. 3.

The resulting adhesive tapes are identified as K-“identifier of the adhesive compound”. Examples of the disclosure are those in which one of the adhesive compounds of the disclosure is used.

The adhesive tapes were tested in respect of their electrical detachability based on strength of adhesion on steel; the strength of adhesion was tested before applying a voltage and further test specimens had a voltage of 12 V applied for 60 seconds before determining the strength of adhesion.

The voltage was in this case applied at the lateral overhang of the Sn-coated carrier material and at one of the steel substrates.

The adhesive tapes were also investigated in respect of static and dynamic shear strength.

Further details on the test methods are given in the “Test methods” section below.

The results are collated in Table 6.

TABLE 6

| Properties | K-I7 | K-I8 | K-I9 |
|---|---|---|---|
| Strength of adhesion/ | 11.1 | 9.7 | 10.7 |
| steel, RT [N/cm] | | | |
| Strength of adhesion/ | 1.6 | 0.1 | 0.1 |
| steel, RT after 12 V, | | | |
| 60 s [N/cm] | | | |
| Strength of adhesion/ | 10.6 | 10.0 | 10.1 |
| steel, 60° C., 95% RH | | | |
| [N/cm] | | | |
| Strength of adhesion/ | 0.04 | 0.04 | 0.05 |
| steel, 60° C., 95% RH, | | | |
| after 12 V, 60 s [N/cm] | | | |
| Dyn. shear strength | 1.03 | 0.93 | 0.92 |
| [N/mm²] | | | |
| Stat. shear strength | 222 | 1128 | 723 |
| [min] | | | |

All examples of the present disclosure show a significant decrease in strength of adhesion when applying a voltage of 12 V for 60 s. The steel plate was in each case free of residues, i.e. remnants of the adhesive compound.

In addition, all examples of the present disclosure display significantly enhanced shear resistance (static and/or dynamic) compared to the comparative examples. Thus, only the examples of the present disclosure and not the comparative examples show excellent electrical detachability where there had previously been high strength of adhesion prior to applying the voltage, and at the same time high shear strengths. The examples of the present disclosure are thus at a higher level in terms of the conflict in aims of the properties under consideration.

In addition, all examples of the present disclosure show good corrosion resistance.

### Adhesive Transfer Tapes of the Disclosure

In the case of adhesive compounds I4 and I8, a 150 μm thick adhesive transfer tape consisting of the respective adhesive compound layer I4 or I8 was produced in a manner known to those skilled in the art.

These also showed a reduction in strength of adhesion after applying a voltage of 12 V for 60 s, and good shear strengths.

### Test Methods

Unless otherwise stated, all measurements are carried out at 23° C. and 50% relative humidity. The mechanical and adhesion data were determined as follows:

### Molecular Weight (GPC)

The reported values for the number-average molecular mass Mn and weight-average molecular mass MW in this document refer to the known determination by gel-permeation chromatography (GPC). The determination is carried out on a clear-filtered 100 μl sample (sample concentration 4 g/l). The eluent employed is THF containing 0.1% by volume of trifluoroacetic acid. The measurement is carried out at 25° C.

The precolumn used is a type PSS-SDV column, 5 μm, 10³ Å, 8.0 mm*50 mm (values here and hereinafter in the following sequence: type, particle size, porosity, internal diameter * length; 1 Å=10⁻¹⁰ m). The separation employs a combination of type PSS-SDV columns, 5 μm, 10³ Å and also 10⁵ Å and 10⁶ Å, in each case 8.0 mm*300 mm (columns from Polymer Standards Service; detection using a Shodex RI71 differential refractometer). The flow rate is 1.0 ml per minute. The calibration is carried out using the commercially available ReadyCal® Kit Poly(styrene) high from PSS Polymer Standard Service GmbH, Mainz. The values obtained are converted (universal calibration) into polymethyl methacrylate (PMMA) using the Mark-Houwink parameters K and alpha, so that the data are expressed in PMMA mass equivalents.

### K Value

The principle of the method is based on the capillary viscometric determination of the relative solution viscosity. For this, the test substance is dissolved in toluene by shaking for thirty minutes so as to obtain a 1% solution. In a Vogel-Ossag viscometer, the flow time is measured at 25° C. and the relative viscosity of the sample solution determined therefrom in relation to the viscosity of the pure solvent. The K value can be read from tables according to Fikentscher in a manner known to those skilled in the art (K=1000 k).

### DSC

The glass transition points—synonymously referred to as glass transition temperatures—in particular of polymers or polymer blocks are reported as the result of measurements by differential scanning calorimetry (DSC). For this, approx. 5 mg of an untreated polymer sample is weighed into a small aluminum crucible (volume 25 μl) and closed with a perforated lid. A DSC 204 F1 from Netzsch is used for the measurement. Operations are carried out under nitrogen for inertization. The sample is first cooled to −150° C., then heated at a heating rate of 10 K/min to +150° C. and cooled again to −150° C. The subsequent second heating curve is recorded again at 10 K/min, and the change in the heat capacity is recorded. Glass transitions are recognized as steps in the thermogram.

### Softening Temperature (of the Tackifier Resin)

For individual substances: The softening temperature of the tackifier resin (softening point; soft. point) is carried out according to the relevant method, which is known as ring & ball and is standardized according to ASTM E28.

### DACP

5.0 g of test substance (the tackifier resin sample under investigation) is weighed into a dry sample bottle and 5.0 g of xylene (isomer mixture, CAS [1330-20-7], ≥98.5%, Sigma-Aldrich #320579 or comparable) is added. The test substance is dissolved at 130° C. and then cooled to 80° C. Any xylene that escapes is replenished with additional xylene, so that 5.0 g of xylene is again present. 5.0 g of diacetone alcohol (4-hydroxy-4-methyl-2-pentanone, CAS [123-42-2], 99%, Aldrich #H41544 or comparable) is then added. The sample bottle is shaken until the test substance has dissolved completely. For this, the solution is heated to 100° C. The sample bottle containing the resin solution is then introduced into a Chemotronic Cool cloud point measuring device from Novomatics, where it is heated to 110° C. It is then cooled at a cooling rate of 1.0 K/min. The cloud point is detected optically. For this, the temperature at which the turbidity of the solution is 70% is registered. The result is reported in ° C. The lower the DACP value, the higher the polarity of the test substance.

### MMAP

5.0 g of test substance (the tackifier resin specimen under investigation) is weighed into a dry sample bottle and 10 mL of dry aniline (CAS [62-53-3], ≥99.5%, Sigma-Aldrich #51788 or comparable) and 5 mL of dry methylcyclohexane (CAS [108-87-2], 99%, Sigma-Aldrich #300306 or comparable) are added. The sample bottle is shaken until the test substance has dissolved completely. For this, the solution is heated to 100° C. The sample bottle containing the resin solution is then introduced into a Chemotronic Cool cloud point measuring device from Novomatics, where it is heated to 110° C. It is then cooled at a cooling rate of 1.0 K/min. The cloud point is detected optically. For this, the temperature at which the turbidity of the solution is 70% is registered. The result is reported in ° C. The lower the MMAP value, the higher the aromaticity of the test substance.

### Peel Adhesion/Steel

To test the strength of adhesion (peel adhesion) on steel of the layer to be investigated in respect of electrical detachability: A 20 mm wide strip of adhesive tape is bonded to a 23 μm thick PET film with the other side, i.e. the adhesive compound layer that does not contain electrolyte. The composite is applied with the side to be investigated in respect of electrical detachability onto a steel plate that has been prewashed twice with acetone and once with isopropanol. The adhesive strip is pressed onto the substrate twice with a contact pressure corresponding to a weight of 2 kg. After an attachment time of 72 h at respectively 23° C. and 50% RH (relative humidity) and at 60° C. and 95% RH, the adhesive tape is peeled off the substrate at a speed of 300 mm/min and at an angle of 180°. All measurements are carried out at room temperature.

The test results are reported in N/cm and are the average of three measurements.

To measure the strength of adhesion after applying a voltage, the adhesive tape is bonded to the steel plate as described above. A DC voltage of 12 V is applied with the negative pole positioned on the steel plate and the positive pole positioned on the overhang of the metalized polymer film or, more precisely, on the free surface of the metal coating.

After 60 s, the voltage is switched off and the sample is immediately clamped into the measuring apparatus and the strength of adhesion measured.

In the case of adhesive transfer tapes, this is bonded between two steel substrates and the voltage applied to the two steel substrates.

### Corrosion Behavior

For the evaluation of corrosion behavior, two aspects are examined. Firstly, the appropriate sample is placed in storage for 72 h at 60° C. and 95% RH as a strip 2 cm in width and is then visually examined. Corrosion of the aluminum layer can then be immediately assessed. If corrosion occurs, either a kind of pitting can be detected or the aluminum is essentially no longer present and the sample is translucent. Secondly, a strip is bonded as described in the peel adhesion method and is likewise placed in storage in hot and humid conditions. After 72 h the bonded sample is taken out of the oven, reconditioned for 2 h, and a voltage applied (see 180° C. peel adhesion test). The loss of strength of adhesion must be clearly measurable. If the aluminum is heavily corroded, it does not conduct the current and the strength of adhesion is not reduced.

### Thickness

The thickness of an adhesive compound layer can be determined by determining the thickness of a section, defined in terms of its length and width, of such an adhesive compound layer applied to a liner, minus the (known or separately determinable) thickness of a section of the same dimensions of the liner used. The thickness of the adhesive compound layer can be determined with accuracies of less than 1 μm deviation using commercially available thickness measuring devices (sensor test devices). If fluctuations in thickness are detected, the average value of measurements in at least three representative places is reported, i.e. in particular not measured at pinches, folds, specks and the like.

As already described above for the thickness of an adhesive compound layer, it is likewise possible to determine in analogous manner the thickness of an adhesive tape (adhesive strip) or of a carrier with accuracies of less than 1 μm deviation using commercially available thickness measuring devices (sensor test devices). If fluctuations in thickness are detected, the average value of measurements in at least three representative places is reported, i.e. in particular not measured at pinches, folds, specks and the like.

### Static Shear Strength at 40° C.

An adhesive tape measuring 13×20 mm was bonded without trapping any air bubbles to a steel plate that had been cleaned with acetone. The back of the adhesive tape was covered with aluminum foil. The bond was rolled on a total of four times with a 2 kg steel roller at a speed of 10 m/min. The test specimen was suspended in a shear test station with integrated heating cabinet (40° C.). The specimen was loaded with 10 N. The test was deemed to have ended when the bond failed or the maximum test time (10 000 min) had been reached. The result is reported in min and is the median of 3 individual measurements.

A good result is a holding power of >200 min.

### Dynamic Shear Strength

An adhesive tape having an edge length of 25 mm×25 mm was bonded without trapping any air bubbles between two steel plates that had been cleaned with acetone. The composite was then compressed for 10 seconds at a force of 62 N and stored for 72 h at 23° C. and 50% RH. The measurement is then carried out on a Zwick tensile testing machine by pulling the two steel plates apart at an angle of 180° at a speed of 50 mm/min and at 23° C. and 50% RH.

The max. force, as the average of 3 measurements, is reported in N/mm².

### LIST OF REFERENCE SIGNS

1 Adhesive compound layer D
2 Electrically conductive carrier layer T
2a Free surface of electrically conductive carrier layer T
3 Second adhesive compound layer C
4 First substrate A
5 Second substrate B
6 Second electrically conductive carrier layer T′
6a Free surface of electrically conductive carrier layer T′
7 Third adhesive compound layer C′

According to a first aspect of the present disclosure, an adhesive compound comprises at least one electrolyte and a base compound, wherein the base compound comprises at least one first phase (i) comprising at least one poly(meth)acrylate, and at least one second phase (ii) comprising at least one vinylaromatic block copolymer, such as in particular styrene block copolymer, wherein the adhesive compound contains at least 2.5 parts by weight of electrolytes based on 100 parts by weight of the base compound.

According to a second aspect of the present disclosure, the adhesive compound of the first aspect is presented, wherein the electrolyte is selected from the group consisting of ionic liquids and metal salts, particular preference being given to ionic liquids.

According to a third aspect of the present disclosure, the adhesive compound of the second aspect is presented, wherein the anion of the ionic liquid is selected from the group consisting of: Br⁻, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻, (CF₃CF₂SO₂)₂N⁻, CF₃CF₂CF₂COO⁻, N(CN)₂⁻, and (FSO₂)₂N⁻, and is particularly preferably selected from (CF₃SO₂)₂N⁻, N(CN)₂⁻, (FSO₂)₂N⁻, PF₆⁻, and tetrafluoroborate (BF₄⁻), and/or the cation of the ionic liquid is selected from the group consisting of imidazolium-based cations, pyridinium-based cations, pyrrolidine-based cations, and ammonium-based cations and is particularly preferably selected from the group consisting of imidazolium-based cations, the cation being particularly preferably selected from the group consisting of 1-ethyl-3-methylimidazolium and 1-butyl-3-methylimidazolium, the cation being very particularly preferably 1-ethyl-3-methylimidazolium.

According to a fourth aspect of the present disclosure, the adhesive compound of any one of the first through third aspects is presented, wherein the electrolyte is selected from the group consisting of the ionic liquids 1-ethyl-3-methylimidazolium dicyanamide, 1-ethyl-3-methylimidazolium bis(trifluoromethylsulfonyl)imide (EMIM-TFSI), 1-ethyl-3-methylimidazolium bis(fluorosulfonyl)imide (EMIM-FSI), 1-butyl-3-methylimidazolium hexafluorophosphate, and 1-ethyl-3-methylimidazolium tetrafluoroborate, preference being given to 1-ethyl-3-methylimidazolium bis(fluorosulfonyl)imide (EMIM-FSI).

According to a fifth aspect of the present disclosure, the adhesive compound of any one of the first through fourth aspects is presented, wherein it contains 2.5 to 10 parts by weight, preferably 2.5 to 8 parts by weight, of electrolytes, preferably ionic liquids, based on 100 parts by weight of the base compound.

According to a sixth aspect of the present disclosure, the adhesive compound of any one of the first through fifth aspects is presented, wherein the base compound contains 51% to 90% by weight, preferably 60% to 80% by weight, of phase (i), and 10% to 49% by weight, preferably 20% to 40% by weight, of phase (ii).

According to a seventh aspect of the present disclosure, the adhesive compound of any one of the first through sixth aspects is presented, wherein the base compound contains 40% to 70% by weight, more preferably 45% to 60% by weight, of at least one poly(meth)acrylate in phase (i) and 15% to 50% by weight of at least one vinylaromatic block copolymer in phase (ii), in each case based on the total weight of the base compound.

According to an eighth aspect of the present disclosure, the adhesive compound of any one of the first through seventh aspects are presented, wherein it is a pressure-sensitive adhesive compound.

According to a ninth aspect of the present disclosure, the adhesive compound of any one of the first through eighth aspects are presented, wherein the base compound comprises at least one filler, preferably selected from the group consisting of microballoons, preferably unexpanded microballoons, having a layer of magnesium hydroxide (Mg(OH)₂) on their surface.

According to a tenth aspect of the present disclosure, the adhesive compound of any one of the first through ninth aspects are presented, wherein the base compound comprises at least one tackifier resin, the tackifier resin preferably being contained in phase (i).

According to an eleventh aspect of the present disclosure, the adhesive compound of any one of the first through tenth aspects are presented, wherein the tackifier resin is selected from the group consisting of rosin derivatives, in particular rosin esters, (meth)acrylate resins, and terpene-phenol resins.

According to a twelfth aspect of the present disclosure, the adhesive compound of any one of the first through eleventh aspects are presented, wherein the poly(meth)acrylate is produced by polymerization of n-butyl acrylate and/or 2-ethylhexyl acrylate and/or methyl acrylate and/or benzyl (meth)acrylate and acrylic acid.

According to a thirteenth aspect of the present disclosure, the adhesive compound of any one of the first through twelfth aspects are presented, wherein the poly(meth)acrylate has a weight-average molecular weight Mw of from 20 000 to 2 000 000 g/mol, particularly preferably from 100 000 to 1 500 000 g/mol, very particularly preferably from 150 000 to 1 200 000 g/mol, even more preferably from 600 000 to 1 200 000 g/mol, in particular from 700 000 to 900 000 g/mol.

According to a fourteenth aspect of the present disclosure, an adhesive tape comprises at least one adhesive compound layer D of an adhesive compound of any one of the first through thirteenth aspects.

According to a fifteenth aspect of the present disclosure, the adhesive tape of the fourteenth aspect is presented, wherein the adhesive tape is an adhesive transfer tape and consists of the adhesive compound layer D.

According to a sixteenth aspect of the present disclosure, the adhesive tape of the fourteenth aspect is presented, wherein it additionally comprises at least the following layers: a second adhesive compound layer C; and at least one electrically conductive carrier layer T that is arranged between layers D and C.

According to a seventeenth aspect of the present disclosure, the adhesive tape of the fourteenth aspect is presented, wherein it additionally comprises at least the following layers: a second adhesive compound layer C; at least one first electrically conductive carrier layer T that is arranged between layers D and C; at least one second electrically conductive carrier layer T′ that is arranged on the surface of the adhesive compound layer D on the opposite side to the first electrically conductive carrier layer T; and a third adhesive compound layer C′ that is arranged on the surface of the second carrier layer T′ on the opposite side to the first adhesive compound layer D.

According to an eighteenth aspect of the present disclosure, a bonded composite comprises at least the following layers: a first substrate A; a second substrate B; and an adhesive tape of any one of the fourteenth through seventeenth aspects that is arranged between the substrate A and the substrate B and bonds the substrates A and B together, wherein, in particular, either the substrate A and the substrate B, or at least one of the substrates and the adhesive tape, or none of the substrates and the adhesive tape, are designed to be electrically conductive at two different points.

According to a nineteenth aspect of the present disclosure, a method for electrically debonding the composite of the eighteenth aspect comprises at least the following method step: i.) applying a voltage at two different points in the composite, the voltage preferably being from 2 to 50 V.

According to a twentieth aspect of the present disclosure, an article comprising components bonded together with the adhesive compound of any one of the first through thirteenth aspects, wherein the article is an electronic device, an automobile, a medical device, or a dental device.

What is claimed is:

1. An adhesive compound comprising at least one electrolyte and a base compound, wherein the base compound comprises at least one first phase (i) comprising at least one poly(meth)acrylate, and at least one second phase (ii) comprising at least one vinylaromatic block copolymer, wherein the adhesive compound contains at least 2.5 parts by weight of electrolytes based on 100 parts by weight of the base compound.

2. The adhesive compound of claim 1, wherein the at least one electrolyte is selected from the group consisting of ionic liquids and metal salts.

3. The adhesive compound of claim 1, wherein the at least one electrolyte comprises an ionic liquid, the ionic liquid comprising
an anion that is selected from the group consisting of: Br⁻, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻, (CF₃CF₂SO₂)₂N⁻, CF₃CF₂CF₂COO⁻, N(CN)₂⁻, and (FSO₂)₂N⁻, and
a cation selected from the group consisting of imidazolium-based cations, pyridinium-based cations, pyrrolidine-based cations, and ammonium-based cations.

4. The adhesive compound of claim 1, wherein the at least one electrolyte is selected from the group consisting of the ionic liquids 1-ethyl-3-methylimidazolium dicyanamide, 1-ethyl-3-methylimidazolium bis(trifluoromethylsulfonyl)imide (EMIM-TFSI), 1-ethyl-3-methylimidazolium bis(fluorosulfonyl)imide (EMIM-FSI), 1-butyl-3-methylimidazolium hexafluorophosphate, and 1-ethyl-3-methylimidazolium tetrafluoroborate.

5. The adhesive compound of claim 1, wherein the adhesive compound contains 2.5 to 10 parts by weight of the at least one electrolyte based on 100 parts by weight of the base compound.

6. The adhesive compound of claim 1, wherein the base compound contains 51% to 90% by weight of phase (i) and 10% to 49% by weight of phase (ii).

7. The adhesive compound of claim 1, wherein the base compound contains 40% to 70% by weight of at least one poly(meth)acrylate in phase (i) and 15% to 50% by weight of at least one vinylaromatic block copolymer in phase (ii), in each case based on the total weight of the base compound.

8. The adhesive compound of claim 1, wherein it is a pressure-sensitive adhesive compound.

9. The adhesive compound of claim 1, wherein the base compound comprises microballoons comprising a layer of magnesium hydroxide (Mg(OH)₂) on their surface.

10. The adhesive compound of claim 1, wherein the base compound comprises at least one tackifier resin.

11. The adhesive compound of claim 10, wherein the tackifier resin is selected from the group consisting of rosin derivatives.

12. The adhesive compound of claim 1, wherein the poly(meth)acrylate is produced by polymerization of (a) one or more of n-butyl acrylate and 2-ethylhexyl acrylate, (b) acrylic acid, and (c) one or more of methyl acrylate and benzyl (meth)acrylate.

13. The adhesive compound of claim 1, wherein the at least one poly(meth)acrylate has a weight-average molecular weight Mw of from 20 000 to 2 000 000 g/mol.

14. An adhesive tape comprising at least one adhesive compound layer D of the adhesive compound of claim 1.

15. The adhesive tape of claim 14, wherein the adhesive tape is an adhesive transfer tape and consists of the adhesive compound layer D.

16. The adhesive tape of claim 14 further comprising at least the following layers: a second adhesive compound layer C and at least one electrically conductive carrier layer T that is arranged between layers D and C.

17. The adhesive tape of claim 14, wherein it additionally comprises at least the following layers: a second adhesive compound layer C; at least one first electrically conductive carrier layer T that is arranged between layers D and C; at least one second electrically conductive carrier layer T′ that is arranged on the surface of the adhesive compound layer D on the opposite side to the first electrically conductive carrier layer T; and a third adhesive compound layer C′ that is arranged on the surface of the second carrier layer T′ on the opposite side to the first adhesive compound layer D.

18. A bonded composite comprising the following layers: a first substrate A; a second substrate B; and the adhesive tape of claim 14 that is arranged between the substrate A and the substrate B and bonds the substrates A and B together, wherein, in particular, either the substrate A and the substrate B, or at least one of the substrates and the adhesive tape, or none of the substrates and the adhesive tape, are designed to be electrically conductive at two different points.

19. A method for electrically debonding the composite of claim 18, comprising:
applying a voltage at two different points in the composite, the voltage preferably being from 2 to 50 V.

20. The adhesive compounds of claim 1, wherein
the base compound contains 60% to 80% by weight of phase (i), and 20% to 40% by weight of phase (ii),
the base compound contains 45% to 60% by weight of at least one poly(meth)acrylate in the at least one first phase (i) and 15% to 50% by weight of at least one styrene block copolymer in the at least one second phase (ii), in each case based on the total weight of the base compound,
the at least one poly(meth)acrylate has a weight-average molecular weight Mw of from 700 000 to 900 000 g/mol,
the base compound comprises unexpanded microballoons comprising a layer of magnesium hydroxide (Mg(OH)₂) on surfaces thereof,
the base compound comprises at least one tackifier resin contained in the at least one first phase (i), the at least one tackifier resin selected from the group consisting of rosin esters, (meth)acrylate resins, and terpene-phenol resins, and
the adhesive compound contains 2.5 to 8 parts by weight of an ionic liquid as the at least one electrolyte, based on 100 parts by weight of the base compound, the ionic liquid comprising
an anion that is selected from the group consisting of: (CF₃SO₂)₂N⁻, N(CN)₂, (FSO₂)₂N⁻, PF₆⁻, and tetrafluoroborate (BF₄⁻), and
a cation selected from the group consisting of 1-ethyl-3-methylimidazolium and 1-butyl-3-methylimidazolium.
